(19) United States
(12) Patent Application Publication
(10) Pub. No.: US 2025/0178297 A1
(43) Pub. Date: Jun. 5, 2025

(54) Scalable Manufacturing of Sustainable Composite Materials with Tunable Thermoregulating Properties

(71) Applicant: The Regents of the University of California, Oakland, CA (US)

(72) Inventors: Alon A. Gorodetsky, Irvine, CA (US); Mohsin Badshah, Irvine, CA (US); Panyiming Liu, Irvine, CA (US); Erica Leung, Piedmont, CA (US); Aleksandra Strzelecka, Irvine, CA (US)

(73) Assignee: The Regents of the University of California, Oakland, CA (US)

(21) Appl. No.: 18/843,658

(22) PCT Filed: Mar. 6, 2023
(86) PCT No.: PCT/US2023/063803

§ 371 Date: Sep. 3, 2024

Related U.S. Application Data
(60) Provisional application No. 63/268,916, filed on Mar. 4, 2022.

(51) Int. Cl. B29D 7/01; B29K 9/06; B29K 105/00; B29K 105/16; B29K 505/10

(52) U.S. Cl. CPC B29D 7/01; B29K 2009/06; B29K 2105/0085; B29K 2105/16; B29K 2505/10; B29K 2995/0026; B29K 2995/003; B29K 2995/0097

(57) ABSTRACT

Methods for large scale fabrication of thermoregulating composite materials and parts comprising thereof are described, as well as methods for heat management using the same. The fabrication methods are easily scalable, highly modular, inexpensive, and capable of producing large area, thin, flexible films of any shape, and having tunable dynamic heat-management properties actuated via low energy input mechanical strain.

### CROSS-REFERENCE TO RELATED APPLICATIONS

The present application claims priority under 35 U.S.C. 119(e) to U.S. Provisional Application No. 63/268,916, filed on Mar. 4, 2022, the disclosure of which is incorporated herein by reference in its entirety.

### STATEMENT REGARDING FEDERALLY SPONSORED RESEARCH

This invention was made with Government support under cooperative agreement D19AC00003 awarded by the Defense Advanced Research Projects Agency; cooperative agreement DE-AR0000534 awarded by the Advanced Research Projects Agency-Energy; and Grant No. FA2386-14-1-3026 awarded by the Air Force Office of Scientific Research. The Government has certain rights in this invention.

### FIELD OF THE INVENTION

The current disclosure is directed to methods for scalable fabrication of thermoregulating composite materials having IR-reflectance properties that are adjustable within the broadband mid-infrared region of the electromagnetic spectrum, and also to methods for fabrication of parts comprising thereof; as well as methods of use thereof for heat management with precise control.

### BACKGROUND OF THE INVENTION

Effective thermal management has proven critical for technologies in various industries, including smart clothing, food packaging, electronic devices, automotive components, and environmental control. For example, the development of sustainable food and beverage packaging technologies constitutes a critical societal concern that could globally influence public health, economic development and national security, as discussed, for example, in: Han, J. H. Innovations in Food Packaging 2nd ed. (Elsevier, 2014); Robertson, G. L. Food Packaging: Principles and Practice 3rd edn (CRC Press, 2016); Saba, N.; et al. Biopolymers and Biocomposites from Agro-Waste for Packaging Applications (Elsevier, 2021); Youssef, A. M.; et al. Bionanocomposites materials for food packaging applications: concepts and future outlook. Carbohydr. Polym. 193, 19-27 (2018); Matthews, C.; et al. A review on European Union's strategy for plastics in a circular economy and its impact on food safety. J. Clean. Prod. 283, 125263 (2021); Anukiruthika, T.; et al. Multilayer packaging: advances in preparation techniques and emerging food applications. Compr. Rev. Food Sci. Food Saf. 19, 1156-1186 (2020); Deshwal, G. K.; et al. Review on metal packaging: materials, forms, food applications, safety and recyclability. J. Food Sci. Technol. 57, 2377-2392 (2020); and Videira-Quintela, D.; et al. Recent advances in polymer-metallic composites for food packaging applications. Trends Food Sci. Technol. 109, 230-244 (2021), the disclosures of which are incorporated herein by reference. Indeed, advanced packaging not only contains and protects food and beverages during storage, but also simplifies distribution logistics, enhances consumer confidence and facilitates written communication. One prominent example of packaging components widely used for food and beverage industries, is a metal coated, or otherwise metallized, plastic film, such as, for example Mylar™ film comprising metal coated biaxially-oriented polyethylene terephthalate (BoPET). Mylar™-like films are commonly integrated into the lining of shipping boxes, warm food covers, candy wrappers, and beverage containers to extend shelf life, by mitigating chemical degradation or microbial contamination (as discussed, for example, in: Piergiovanni, L.; Limbo, S. The protective effect of film metallization against oxidative deterioration and discoloration of sensitive foods. Packag. Technol. Sci. 17, 155-164 (2004); Fu, Y.; Dudley, E. G. Antimicrobial-coated films as food packaging: a review. Compr. Rev. Food Sci. Food Saf. 20, 3404-3437 (2021); and Tyagi, P.; et al. Advances in barrier coatings and film technologies for achieving sustainable packaging of food products—a review. Trends Food Sci. Technol. 115, 461-485 (2021), the disclosures of which are incorporated herein by reference), ensure a consistent thermal environment inside packages (as discussed, for example, in: Singh, S. P.; et al. Performance comparison of thermal insulated packaging boxes, bags and refrigerants for single-parcel shipments. Packag. Technol. Sci. 21, 25-35 (2008); and Singh, S.; et al. Temperature-regulating materials for advanced food packaging applications: a review. J. Food Meas. Charact. 12, 588-601 (2018), the disclosures of which are incorporated herein by reference), and or even function as susceptors during microwave cooking (as discussed, for example, in: Sumnu, G. A review on microwave baking of foods. Int. J. Food Sci. Technol. 36, 117-127 (2001); and Perry, M. R.; Lentz, R. R. in Development of Packaging and Products for Use in Microwave Ovens 2nd edn (eds Erle, U. et al.) 261-291 (Elsevier, 2020), the disclosures of which are incorporated herein by reference). Importantly, various industrial techniques have been developed to inexpensively manufacture these ubiquitous materials on large, commercially relevant scale (see, for examples: Bishop, C. A.; Mount, E. M. in Multilayer Flexible Packaging (ed. Wagner, J. R.) 185-202 (Elsevier, 2009); Vasile, C. Polymeric nanocomposites and nanocoatings for food packaging: a review. Materials 11, 1834 (2018); and Mbam, S. O.; et al. Thin-film coating; historical evolution, conventional deposition technologies, stress-state micro/nano-level measurement/models and prospects projection: a critical review. Mater. Res. Express 6, 122001 (2019), the disclosures of which are incorporated herein by reference). Moreover, such metallized plastic materials can be advantageously repurposed or recycled (as discussed, for example, in: Bayus, J.; et al. A preliminary environmental assessment of foil and metallized film centered laminates. Resour. Conserv. Recycl. 115, 31-41 (2016); and Kaiser, K.; et al. Recycling of polymer-based multilayer packaging: a review. Recycling 3, 1 (2018), the disclosures of which are incorporated herein by reference).

Nevertheless, within the context of sustainability, the development of insulating materials and container components represents an important application and a notorious sustainability challenge (as discussed, for example, in: Changwichan, K.; Gheewala, S. H. Choice of materials for takeaway beverage cups towards a circular economy. Sustain. Prod. Consum. 22, 34-44 (2020); Triantafillopoulos, N.; Koukoulas, A. A. The future of single-use paper coffee cups: current progress and outlook. BioResources 15, 7260-7287 (2020); Foteinis, S. How small daily choices play a huge role in climate change: the disposable paper cup environmental bane. J. Clean. Prod. 255, 120294 (2020); and Chang, A.; et al. An Investigation into Reusable Coffee Mugs (The Univ. of British Columbia, 2011), the disclosures of which are incorporated herein by reference). For example, in the case of insulated beverage containers, such as, for example, coffee cups, nearly two thirds of adults in the USA, alone, drink coffee daily, consuming ˜140 billion cups of coffee annually (as, for example, discussed in: US Coffee Statistics-2020/2021 (Urban Bean Coffee, 2021); https://urbanbeancoffee.com/coffee/usa-coffee-statistics/; and Rehm, C. D.; et al. Coffee consumption among adults in the United States by demographic variables and purchase location: analyses of NHANES 2011-2016 data. Nutrients 12, 2463 (2020), the disclosures of which are incorporated herein by reference). However, the thermoregulating technological solutions currently available to hot beverage drinkers, such as, for example, the ceramic mug, the insulated metal thermos, and the paper sleeve-covered cup-all suffer from various drawbacks, such as substantial manufacturing costs, impractical recyclability, inconvenient form factors, and or leaving a large carbon footprint over their lifetimes. Furthermore, the heat dissipation properties of such containers are typically difficult-to-control. Therefore, such solutions rarely afford an optimal combination of properties, wherein the user can enjoy a comfortable container hold (i.e., the container's external temperature is maintained in the range of ˜20-48° C.), while consuming a drink of a preferred warmth (i.e., the container's internal temperature is maintained in the range of ˜55-70° C.) (as, for example, discussed in: Abraham, J.; Diller, K. A review of hot beverage temperatures satisfying consumer preference and safety. J. Food Sci. 84, 2011-2014 (2019); Brown, F.; Diller, K. R. Calculating the optimum temperature for serving hot beverages. Burns 34, 648-654 (2008); and Lee, H. S.; O'Mahony, M. At what temperatures do consumers like to drink coffee?: Mixing methods. J. Food Sci. 67, 2774-2777 (2002), the disclosures of which are incorporated herein by reference), in a sustainable fashion, and at an affordable cost. As such, there exists a need for packaging solutions that can be manufactured in a straightforward, sustainable, and inexpensive manner, allow for easy recycling, accommodate various form factors of food and beverage, or other, containers, and effectively manage the heat transfer between a package's content and its environment with a minimal external input of energy.

### SUMMARY OF THE INVENTION

Various embodiments are directed to a method of fabricating a composite material with adjustable IR-reflecting properties and having a continuous area of more than 150 cm² including:
providing a flexible substrate characterized by a substrate surface roughness;
depositing a planar layer comprising a first IR-reflecting material and characterized by a planar layer thickness onto the flexible substrate;
growing a plurality of columnar nanostructures comprising a second IR-reflecting material on top of the planar layer at an angle relative to the planar layer to obtain a nanostructured layer characterized by a nanostructured layer thickness;
coating the nanostructured layer with an IR-transparent polymer and allowing the IR-transparent polymer to dry to obtain an elastomeric matrix, characterized by a matrix thickness, such that the nanostructured layer becomes embedded into the elastomeric matrix via the plurality of columnar nanostructures, to provide a robust composite; and
delaminating the robust composite from the flexible substrate, such that the planar layer breaks into a plurality of domains comprising the first IR-reflecting material, separated by a plurality of spacings comprising the IR-transparent polymer,
   to produce a free standing film having the continuous area of more than 150 cm² and comprising the composite material with adjustable IR-reflecting properties.

In various such embodiments, the substrates surface roughness is characterized by a surface roughness RMS value of <1 μm.

In still various such embodiments, the flexible substrate is a material selected from the group consisting of: metal foil, plastic, rubber. In many such embodiments, the metal foil is aluminum foil.

In yet various such embodiments, the first IR-reflecting material and the second IR-reflecting material are materials independently selected from the group consisting of: copper, aluminum, gold, silver, any oxide of titanium, any oxide of vanadium, any oxide of molybdenum, and any oxide of silicon, and any combination thereof.

The method of claim 1, wherein the first IR-reflecting material and the second IR-reflecting material are same materials.

In still yet various embodiments, the planar layer thickness is 10-100 nm.

In various such embodiments, the IR-transparent polymer is a material selected from the group consisting of: SEBS polymers, including various SEBS blends and blends of SEBS with PE and HDPE, PDMS, and any combination thereof.

The method of claim 1, wherein the coating is achieved via a technique selected from the group consisting of: spray-coating, spin-coating, doctor blading, knife coating, slot-die coating, any other solution-based or neat material coating technique, and any combination thereof.

In still various such embodiments, the matrix thickness is 30-40 μm.

Various other embodiments are directed to a method of fabricating a part characterized by a part shape of a part area of less than 150 cm² comprising a composite material with adjustable IR-reflecting properties including:
providing a flexible substrate characterized by a substrate surface roughness;
depositing a planar layer comprising a first IR-reflecting material and characterized by a planar layer thickness onto the flexible substrate;
growing a plurality of columnar nanostructures comprising a second IR-reflecting material on top of the planar layer at an angle relative to the planar layer to obtain a nanostructured layer characterized by a nanostructured layer thickness;
coating the nanostructured layer with an IR-transparent polymer and allowing the IR-transparent polymer to dry to obtain an elastomeric matrix, characterized by a matrix thickness, such that the nanostructured layer becomes embedded into the elastomeric matrix via the plurality of columnar nanostructures, to provide a robust composite; and
delaminating the robust composite from the flexible substrate, such that the planar layer breaks into a plurality of domains comprising the first IR-reflecting material, separated by a plurality of spacings comprising the IR-transparent polymer,
to produce a free standing film having the continuous area of more than 150 cm² and comprising the composite material with adjustable IR-reflecting properties; and
excising the part shape from the free standing film to obtain the part.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIG. 1 illustrates the composition and adjustable morphology of thermoregulating composite materials, wherein stretching induces the adjustment of surface IR-reflecting domains between abutted (left) and separated (right) states, according to prior art.

FIGS. 2A through 2M illustrate the large scale fabrication of the thermoregulating composite materials and characterization thereof, wherein: FIG. 2A schematically illustrates the fabrication of the IR-reflecting layer atop a substrate, wherein a planar component is first deposited onto the substrate via the electron beam evaporation of a IR-reflecting material, followed by the deposition of upright columnar nanostructures (a nanostructured component) on top of the planar component by electron beam evaporation with the incoming flux/particles deposited at an angle “a” over the rotating substrate; and followed by the removal of the IR-reflecting layer (comprising the planar and nanostructured components) from the deposition system; FIG. 2B provides a representative digital camera image of the completed IR-reflecting layer (here, comprising copper as the IR-reflecting material) overlaying the substrate (the scale bar is 2 cm); while FIG. 2C provides a representative top-down SEM images of the same at low (left) and high (right) magnifications (the scale bars are 500 μm (left) and 500 nm (right), respectively); FIG. 2D schematically illustrates the rest of the steps involved in the fabrication process, including spray coating of an elastomeric matrix onto the substrate-overlaying IR-reflecting layer, and delamination of the completed composite material film from the substrate, resulting in formation of IR-reflecting layer domains overlaying the elastomeric matrix and separated by the elastomeric matrix regions; FIG. 2E and FIG. 2F provide a representative digital camera image (the scale bar is 2 cm) and a representative top-down SEM image (the scale bar is 200 μm), respectively, of a large-area, composite material, comprising copper as the IR-reflecting material and styrene-ethylene-butylene-styrene (SEBS) as the elastomeric matrix, mounted on a plastic frame; FIG. 2G schematically illustrates a material equivalent to the composite material having a 20 nm-thick planar components of the IR-reflecting layer in all aspects, except lacking the nanostructured component of the IR-reflecting layer (top); and provides a representative digital camera image of such a material wherein the IR-reflecting layer comprises copper (with noticeable millimeter-scale delamination-caused perforations) (middle); along with a representative top-down SEM image of the same material (also with a noticeable, delamination-caused microscale defect); FIG. 2H schematically illustrates a material fabricated from the composite material by chemically removing the planar component of the IR-reflecting layer (here, comprising copper) (top); and provides a representative digital camera image (middle), as well as a representative top-down SEM image of the same material; FIG. 2I schematically illustrates the composite materials having the planar component of the IR-reflecting layer of varying thicknesses (5 nm, 10 nm, 20 nm, 50 nm, and 100 nm, from left to right, respectively), and provides representative digital camera images (middle) and top-down SEM images (bottom) for each; FIG. 2J schematically illustrates the composite materials with varying planar component thicknesses (5 nm, 10 nm, 20 nm, 50 nm, and 100 nm, from left to right) before and after mechanical actuation (two top rows), as well representative top-down SEM images of the same composite materials under various applied strains of 0%, 30%, 50%, and 100% (top to bottom); FIG. 2K schematically illustrates the procedure used for binarizing the composite materials' representative SEM images into distinct regions of the IR-reflecting material and the underlaying polymer for calculating IR-reflecting domains' width and, as such, the composite material's surface coverage by the IR-reflecting layer; FIG. 2L provides average widths data for the IR-reflecting domains obtained for composite materials with varying planar component thicknesses (5 nm, 10 nm, 20 nm, 50 nm, and 100 nm); while FIG. 2M provides IR-reflecting material surface coverage data for the same composite materials under varied applied strains (of 0%, 30%, 50%, and 100%), wherein the error bars represent standard deviations of the mean, in accordance with embodiments of the application.

FIG. 3A schematically illustrates the fabrication of an arch-shaped part comprising the thermoregulating composite material equipped with fasteners to enable secure wrapping of the part around a standard paper coffee cup, wherein the desired (arch) pattern is first delineated/drawn on the rectangle comprising the thermoregulating composite material, then outfitted via an adhesive with the hook-and-loop components of the fasteners, and excised from the rectangle, while FIG. 3B provides a representative digital camera image of the final product of the fabrication process (the scale bar is 1 in), in accordance with embodiments of the application.

FIG. 4A schematically illustrates the fabrication of a blanket-like composite material, with steps including: trimming of nine substrate-attached rectangles comprising the thermoregulating composite material into smaller rectangles; connecting the nine trimmed smaller rectangles together with an adhesive tape applied to the substrate side, while leaving small gaps between the edges of the nine smaller rectangles; filling the gaps with a syringe-cast solutions of the same polymer as used for the elastomeric polymer; allowing the polymer to dry; and simultaneously delaminating all of the nine rectangles of the obtained assembly from all supporting substrates to produce a single, larger, thermoregulating composite materials sheet; while FIG. 4B provides a representative digital camera image of a resulting thermoregulating composite material quilt comprising copper as the IR-reflecting material (the scale bars is 4 in), in accordance with embodiments of the application.

FIGS. 5A through 5D illustrate and provide data for characterization of the mechanical properties of the composite materials, wherein: FIGS. 5A and 5B illustrate the mechanical properties of the large-area, thermoregulating composite materials, with FIG. 5A providing representative digital camera images of a swath of the composite material undergoing tensile testing, and FIG. 5B providing a representative engineering stress versus strain curve obtained from such tests (wherein the inset shows a close-up of the low-strain region); while FIG. 5C provides a schematic illustration (top), accompanied by the corresponding, representative, top-down SEM images (bottom), that explain the surface morphology changes produced in the thermoregulating composite materials by application of strain, wherein the applied strains are: 0% (left), 30% (middle), and 50% (right) (scale bars, 20 μm); and FIG. 5D provides representative engineering stress versus strain curves for the composite materials with 5 nm, 10 nm, 20 nm, 50 nm, and 100 nm-thick planar components of the IR-reflecting layer (here, comprising copper) and for the elastomeric matrix alone (here, comprising SEBS) (left), and Young's moduli calculated at 30% strain for the same composite materials and SEBS (the error bars represent standard deviations of the mean), in accordance with embodiments of the application.

FIGS. 6A through 6H provide images and data showcasing the adaptive IR-reflecting properties of the large-area, thermoregulating composite materials; wherein FIG. 6A illustrates the mechanism behind the mechanical regulation of the IR-properties of the thermoregulating composite materials (the absorption of infrared light is omitted here for clarity); while FIG. 6B provides representative total reflectance (top) and total transmittance (bottom) spectra obtained for a sample of the thermoregulating composite material subjected to various applied strains; FIG. 6C provides the average values of the total, specular and diffuse reflectance (top) and transmittance (bottom) for the composite materials subjected to different applied strains of <100% (the error bars represent standard deviations); FIG. 6D provides representative mid-infrared total reflectance (top, left) and transmittance (top, right) spectra obtained for a sample of the composite material subjected to various applied strains, as well as the average values of the total reflectance (bottom, left) and total transmittance (bottom, right) for the composite materials at different applied strains of ≤100% over the wavelength ranges of 2.5 μm-25 μm (dark squares), 3.5 μm-18.5 μm (light squares), 4.5 μm-16.5 μm (light triangles), 8 μm-12 μm (dark triangles), 5 μm-8 μm (light circles), and 3 μm-5 μm (dark circles) (the error bars in represent the standard deviations); FIG. 6E provides representative total (solid line), specular (triangles), and diffuse (circles) reflectance spectra obtained for a sample of the composite material subjected to various strains, and FIG. 6F shows the same for the transmittance spectra of the composite material; FIG. 6G schematically illustrates the reflection and transmission of infrared light by the composite material before (left) and after (right) mechanical actuation (here, the comparatively minimal absorption of infrared light is omitted for clarity (top), and provides: the representative total infrared reflectance spectra for the composite materials with varying thicknesses of the planar component of the IR-reflecting layer (here, 5 nm, 10 nm, 20 nm, 50 nm, and 100 nm) under applied strains of 0% (solid lines) and 50% (dashed lines) (middle, left); the average calculated change in total infrared reflectance for the same composite materials under different applied strains of ≤100% (middle, right); the representative total infrared transmittance spectra for the same composite materials under applied strains of 0% (solid lines) and 50% (dashed lines) (bottom, left); and the average calculated change in total infrared transmittance for the same materials under different applied strains of ≤100%; wherein the error bars represent standard deviations of the mean; while FIG. 6H schematically illustrates the reflection and transmission of infrared light by a material fabricated from the composite material by removal of the planar component of the IR-reflecting layer before (top, left) and after (top, right) mechanical actuation (here, the comparatively minimal absorption of infrared light is not depicted for clarity), and provides the representative total infrared reflectance spectra for the material under applied strains of 0% (solid lines) and 50% (dashed lines) (middle, left), the average calculated change in total infrared reflectance for the material under different applied strains of ≤100% (middle, right), the representative total infrared transmittance spectra for the material under applied strains of 0% (solid lines) and 50% (dashed lines) (bottom, left), the average calculated change in total infrared transmittance for the material under different applied strains of ≤100% (bottom, right) (the error bars represent standard deviations of the mean), in accordance with embodiments of the application.

FIGS. 7A and 7B illustrate robustness of the thermoregulating composite materials towards repeating strain cycles, wherein: FIG. 7A provides the representative total reflectance spectra obtained for a sample of the composite material subjected to various applied strains and (from left to right) after increasing number of actuation cycles (top), and the representative total transmittance spectra for all of the same scenarios (bottom); while FIG. 7B provides data comparing the average changes in the total reflectance (top) and the total transmittance (bottom) caused by the application of strain of 30% to a sample of the thermoregulating composite material recorded after 1 actuation cycle, 1000 actuation cycles, 5000 actuation cycles, and 10000 actuation cycles (the error bars represent the standard deviations), in accordance with embodiments of the application.

FIGS. 8A through 8C illustrate tunable heat-management properties of the large-area thermoregulating composite materials, wherein FIG. 8A. shows the hot plate testing setup used in the evaluation of the properties of the composite materials, with the insets showing digital camera images of the composite materials being tested (scale bars are 2 cm); FIG. 8B provides a plot of representative, time-dependent heat flux measurements for the composite material subjected to an applied strain of 0 and 30%, and compares them to the same measurements obtained for a metallized polymer material in absence of any strain; and FIG. 8C provides average heat flux change data calculated for the composite materials subjected to different applied strains (the error bars represent standard deviations), in accordance with embodiments of the application.

FIGS. 9A and 9B compare the tunable heat-management capabilities of the thermoregulating composite material and a conventional metallized polymer material (Mylar™), with FIG. 9A providing: a representative digital camera image of an experimental enclosure comprising a quilt blanket-like composite material part incorporated as one of the enclosure's walls (the scale bars is 6 in) (top); an illustration of the experimental setup, wherein the enclosure covers a hand, and a local mechanical actuation of the material-containing wall (achieved by the hand pressing against/deforming the wall) is monitored by a thermal infrared camera (middle); and representative thermal infrared camera images obtained for the composite material wall before (left) and after (right) the mechanical actuation by the hand (the scale bars are 6 in); while FIG. 9B. provides all the same illustrations and data, in the same order, for the conventional metallized polymer material for comparison (the scale bars are 6 in), in accordance with embodiments of the application.

FIGS. 10A through 10H illustrate the dynamic heat management capabilities of the large-area thermoregulating composite materials with help of a hot beverage handling scenario, wherein FIG. 10A provides an illustration of the experimental setup, wherein each cup system—i.e., a hot coffee-filled paper cup wrapped in a cozy comprising a material of choice-undergoes monitoring with a thermal infrared camera and a system that measures the internal and the external temperature of the cup system; FIG. 10B provides representative time-lapse thermal infrared camera images obtained for various cup systems, wherein the materials of choice include (from left to right): the thermoregulating composite material provided unstrained or strained to different (increasing) degrees, unstrained SEBS, and unstrained Mylar™, obtained after 0 min (top row), 60 min (middle row) and 90 min (bottom row); while FIGS. 10C and 10D provide external and internal, respectively, temperature differences observed between a cup system and an unwrapped cup standard measured at 90 min of the experiment for each cup system (the error bars represent standard deviations); FIG. 10E provides plots comparing the external temperatures measured as a function of time for each cup system and also for an unwrapped cup; FIG. 10F provides the average external cooling rates measured for each cup system and also for an unwrapped cup (the error bars represent the standard deviations); FIG. 10G provides plots comparing the internal temperatures measured as a function of time for each cup system and also for an unwrapped cup; FIG. 10H provides the average internal cooling rates measured for each cup system and also for an unwrapped cup (the error bars represent the standard deviations), in accordance with embodiments of the application.

FIG. 11 schematically illustrates a cup system configuration used for development of the computation model for describing and predicting heat transfer between the thermoregulating composite material-covered coffee-filled cups and the external environment, in accordance with embodiments of the application.

FIGS. 12A through 12C provide theoretically derived data obtained from the computational model developed to predict the heat transfer behavior of the thermoregulating composite materials used for heat management in a hot liquid-filled cup system scenario, wherein FIG. 12A provides the external temperatures calculated as a function of time for various cup systems and for a bare cup used as a standard (top), and the corresponding predicted external cooling rates (bottom); FIG. 12B provides the internal temperatures calculated as a function of time for various cup systems and for a bare cup used as a standard (top), and the corresponding predicted internal cooling rates (bottom); and FIG. 12C provides theoretically derived external (top) and internal (bottom) temperature differences expected between a cup system and an unwrapped cup standard measured at 90 min of the experiment for each cup system, in accordance with embodiments of the application.

FIG. 13 schematically illustrates and provides data for computational simulation of the infrared properties of the composite materials, wherein the top image schematically illustrates the model used to computationally simulate the reflection and transmission of infrared light by the composite material before (left) and after (right) mechanical actuation (with the minimal absorption of infrared light being omitted for clarity); the middle left image provides the simulated total infrared reflectance spectra obtained for the composite materials with varying thickness of the planar component of the IR-reflecting layer (i.e., 5 nm, 10 nm, 20 nm, 50 nm, and 100 nm thicknesses) under applied strains of 0% (solid lines) and 50% (dashed lines); the middle right image provides the average calculated change in simulated total infrared reflectance for the same composite materials under different applied strains of ≤100%; the bottom left image provides the simulated total infrared transmittance spectra for the same composite materials for applied strains of 0% (solid lines) and 50% (dashed lines); and bottom right images provides the average calculated change in simulated total infrared transmittance for the same composite materials under different applied strains of ≤100%, in accordance with embodiments of the application.

### DETAILED DISCLOSURE

Turning now to the schemes, images, and data, the methods for fabrication of thermoregulating composite materials with adjustable spectral properties, such that they are capable of dynamically controlling IR radiation transmission are described, wherein the methods allow fabrication of such materials on a large, industrially meaningful, scale, as well as methods of fabrication of parts and systems comprising thereof; and methods of using the same for controllable heat management. It will be understood that the embodiments of the invention described herein are not intended to be exhaustive or to limit the invention to precise forms disclosed. Rather, the embodiments selected for description have been chosen to enable one skilled in the art to practice the invention.

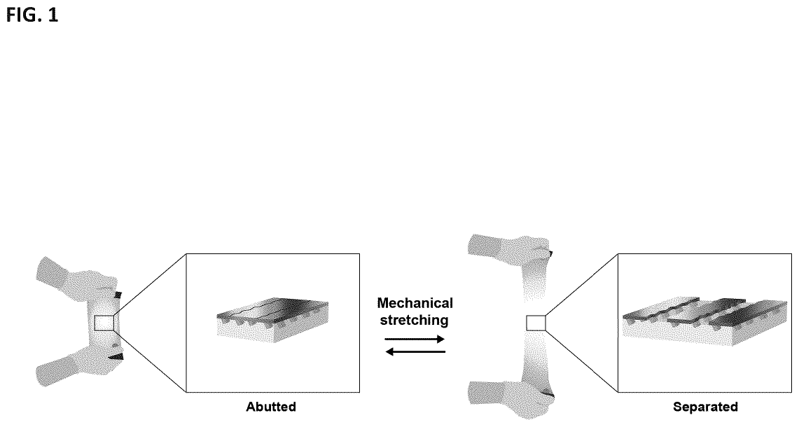

A number of thermal management technologies has shown tremendous promise to date. Some notable examples include: variable-emissivity phase-changing materials, tunable metasurfaces, infrared electrochromic devices, portable heating and refrigeration systems, and elastomeric or pneumatic actuators (e.g., see: Rai, V.; et al. A review on recent advances in electrochromic devices: a material approach. Adv. Eng. Mater. 22, 2000082 (2020); Hu, R.; et al. Emerging materials and strategies for personal thermal management. Adv. Energy Mater. 10, 1903921 (2020); Wei, H.; et al. Smart materials for dynamic thermal radiation regulation. Small 17, 2100446 (2021); Dou, S.; et al. Bioinspired microstructured materials for optical and thermal regulation. Adv. Mater. 33, 2000697 (2021); and Yang, J.; et al. Beyond the visible: bioinspired infrared adaptive materials. Adv. Mater. 33, 2004754 (2021), the disclosures of which are incorporated herein by reference). More recently, the engineering of bioinspired platforms with user-tunable infrared or thermoregulatory functionalities, inspired by the skin of the common squid, has also been reported (e.g., see: Xu, C.; et al. Adaptive infrared-reflecting systems inspired by cephalopods. Science 359, 1495-1500 (2018); and Leung, E. M.; et al. A dynamic thermoregulatory material inspired by squid skin. Nat. Commun. 10, 1947 (2019), the disclosures of which are incorporated herein by reference). More specifically, these recent reports describe metallized composite materials, featuring metal domains overlaying a surface of an elastomeric matrix, such that stretching of the elastomeric matrix changes the distance between the metal domains (i.e., stretching of the composite material separates the initially abutted metal domains on its surface), and, thus, affects the overall infrared reflectance and transmittance properties of the composite material (FIG. 1). However, to date, no report of a thermoregulating material or technology has described in sufficiently enabling detail how to manufacture such material or technology in a robust, scalable, and modular way, such as to allow practical, large scale manufacturing, nor how to use such material or technology for thermoregulation of large areas with good control and precision.

This application is directed to embodiments of methods for manufacturing of squid-inspired, sustainable, thermoregulating composite materials and parts comprising thereof to large, commercially valuable scale, and to methods for adjusting the heat management properties of such materials and parts in real time with robust precision. In many embodiments, the thermoregulating composite materials and parts manufactured and used according to the methods disclosed herein allow for heat management over large areas with good control. In many embodiments, the composite materials feature broadband mid-infrared functionalities, and are robust and stable in a variety of environments and conditions over extended periods of repeated cycling when used for thermal regulation according to the methods described herein. In many embodiments, the thermoregulating performance of the instant composite materials is computationally predictable and tunable according to the methods and computational models disclosed herein, such as to optimize their performance for any particular heat management application and or scenario. In many embodiments, the disclosed methods allow for fabrication of large-area thermoregulating composite materials, and parts comprising thereof, with variable shapes and or form factors. In many embodiments, the manufacturing of the thermoregulating composite materials according to the instant methods is inexpensive, highly modular, and relies on industrially relevant manufacturing techniques, that employ inexpensive, readily available starting materials. In many embodiments, the thermoregulating composite materials manufactured according to the methods disclosed herein feature composite morphologies that can be mechanically reconfigured to tune the infrared radiation reflecting properties of the thermoregulating composite materials over a broad IR spectral range. In many embodiments, the thermoregulating composite materials manufactured according to the methods are stable after repeated mechanical cycling/use. In many embodiments, the thermoregulating composite materials manufactured according to the methods of the instant application demonstrate dynamic thermal management capabilities over large-areas in various thermoregulating applications, including packaging-relevant applications, and wearables applications. In many embodiments, the computational methods and models described herein allow for excellent control over heat management properties of the thermoregulating composite materials and part comprising thereof in various desired applications and scenarios. In some embodiments, the thermoregulating composite materials are designed and manufactured for packaging applications, such as to package goods requiring thermally regulated storage and or use, including low-power, portable heating and refrigeration systems. In some such embodiments, the composite materials are designed and manufactured for beverage and or food-packaging applications. In some embodiments, the thermoregulating composite materials are designed and manufactured for use as components in wearable systems to regulate transmission of heat by the wearer. In many such embodiments, the thermal management systems incorporating the composite material are articles of clothing or clothing components, such as, for example, sleeves or panels. In some embodiments, the thermoregulating composite materials are designed and manufactured for other thermoregulating applications, such as, for example, building envelopes and tunable metasurfaces. Accordingly, in many embodiments, the thermoregulating composite materials of the instant application represent viable alternatives to the static infrared-reflecting metallized films routinely used in packaging or other applications requiring heat transfer control.

### Scalable and Modular Manufacturing of the Thermoregulating Composite Materials and Parts Comprising Thereof

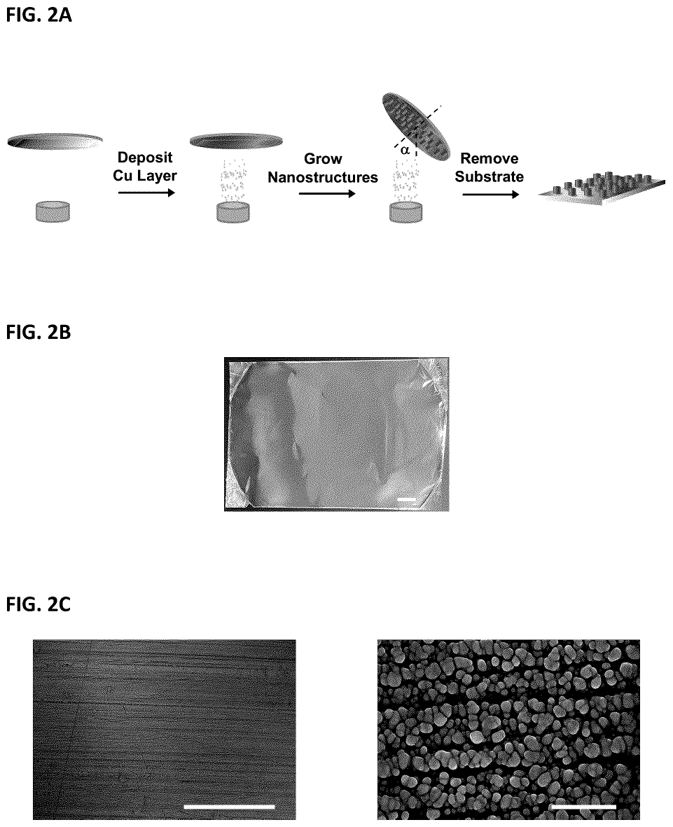

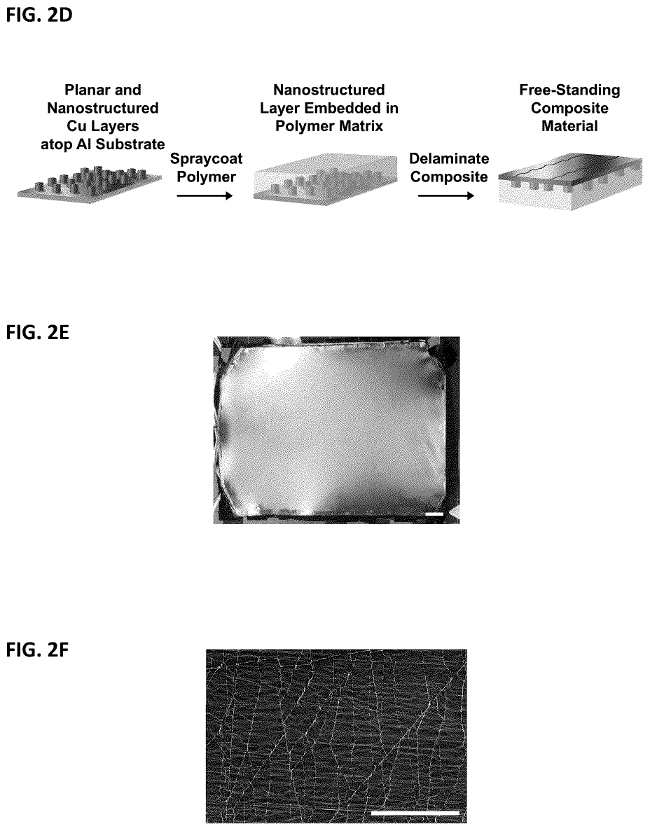

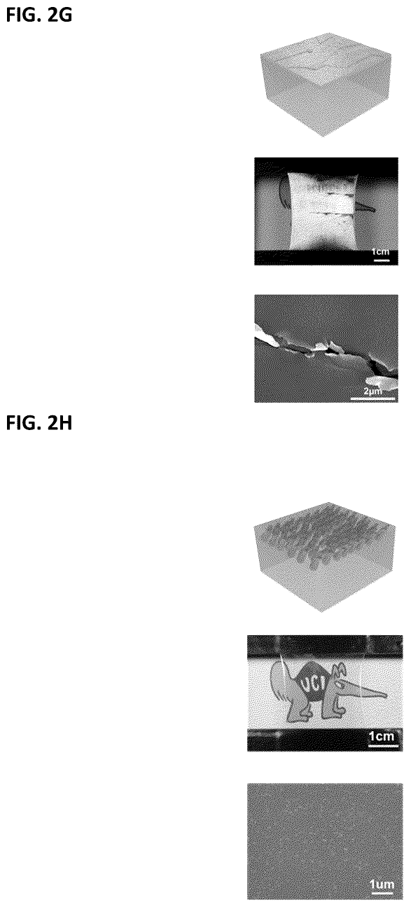

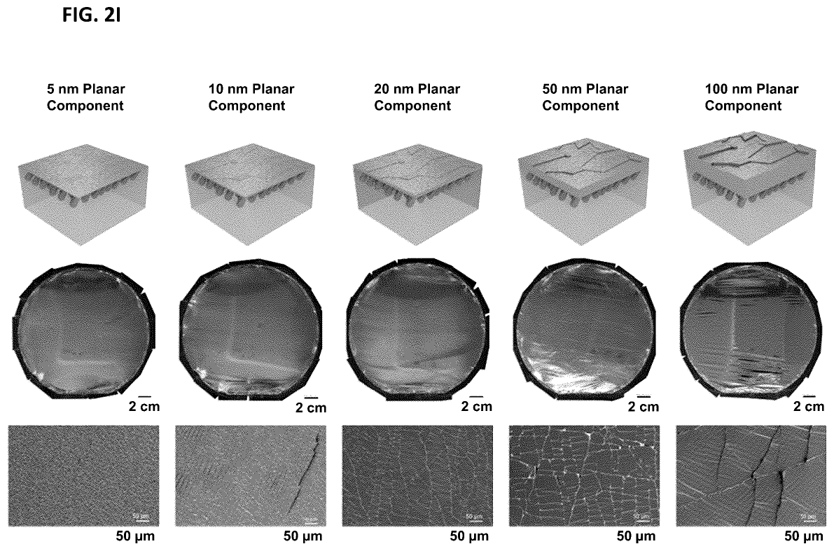

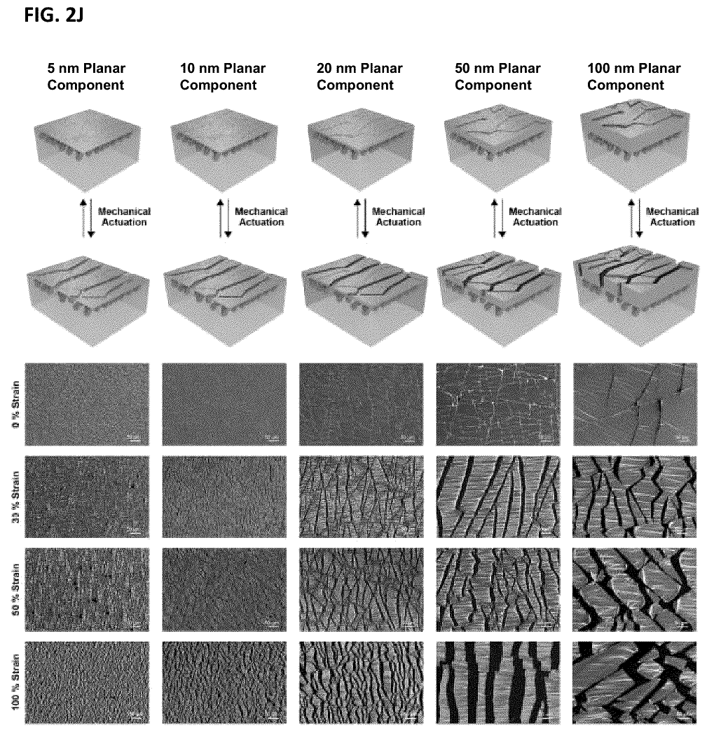

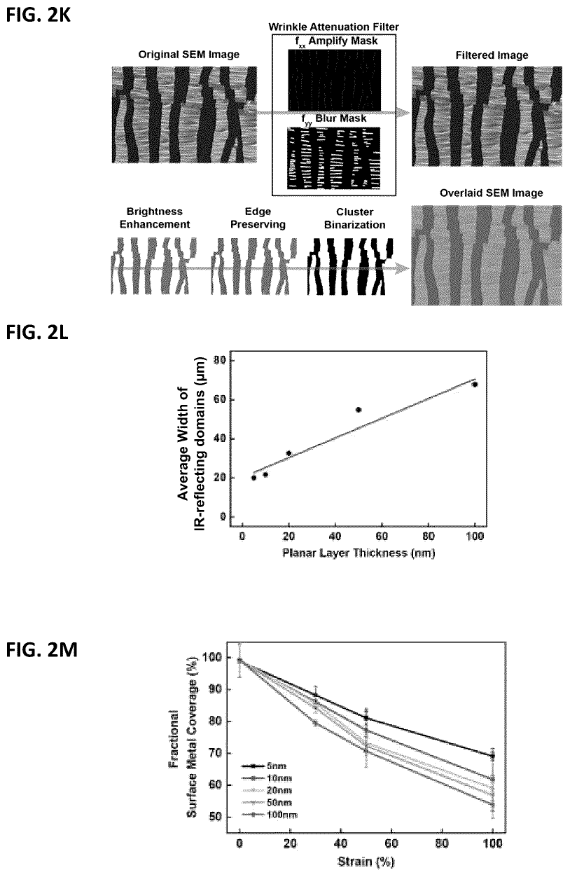

FIGS. 2A through 2F illustrate manufacturing process used in the large scale fabrication of the thermoregulating composite materials according to many embodiments, wherein the process comprises embedding a nanostructured infrared-reflecting layer (e.g., a layer of metal, such as copper) into a stretchable infrared-transparent elastomeric matrix. Here, “large” scale refers to any scale larger than laboratory (“small”) scale, wherein, in a laboratory setting, it is conventional to use 6 inch (in diameter) wafers, which maybe further trimmed as needed, for laboratory scale vapor deposition techniques. As such, laboratory fabrication techniques that comprise at least one vapor deposition step are typically constrained by ˜150 cm² manufacturing area, resulting in smaller parts. Accordingly, in many embodiments, the large scale manufacturing of the thermoregulating composite materials and parts having areas larger than 150 cm², including as large as 570 cm², or larger, requires substantial some non-trivial modification of the procedures and implements, as compared to those employed in the preparation of the analogous composite materials on a smaller, laboratory scale.

To this end, in many embodiments, first, to fabricate the nanostructured component of the infrared-reflecting layer of the thermoregulating composite material, a planar layer of an infrared-reflecting material, such as, for example, a metal, is first deposited onto a flexible substrate to create the planar component of the IR-reflecting layer and, then, upright columnar nanostructures of the same (or, in some embodiments, another) IR-reflecting material are grown on top of the planar layer/component (FIG. 2A). In many embodiments, the infrared-reflecting planar component is 20-100 nm thick. In many embodiments, the thickness of the planar component affects the surface morphology of the resulting composite material and, as such, its thermoregulating properties. In many embodiments, the infrared-reflecting material is a metal, or a metal oxide, or another oxide. In many embodiments, the metal is a metal selected from the group consisting of, but not limited to: copper (Cu), aluminum (Al), gold (Au), silver (Ag), and any combination thereof. In many embodiments, the metal oxide or another oxide is an oxide selected from the group consisting of, but not limited to: any oxide of titanium, any oxide of vanadium, any oxide of molybdenum, and any oxide of silicon. In many embodiments, the columnar nanostructures comprising IR-reflecting material are deposited (grown) at a deposition angle α relative to the deposition flux (FIG. 2A). In many embodiments, a is in the range of 75°-89°. In many embodiments, the columns of the columnar nanostructures are less than 1 μm in diameter. In many embodiments, the columns of the columnar nanostructures are upright relative to the deposition substrate's/planar component's surface, while in some other embodiments, the columns are slanted relative to the deposition substrate's/planar component's surface. In many embodiments, the extent of the slant of the nanostructure columns relative to the deposition surface is primary dictated by the fabrication conveniences and does not affect the overall thermoregulating composite material properties and robustness.

In many embodiments, the flexibility of the deposition step's flexible substrate allows for facile scaling up of the fabrication of the infrared-reflecting layer (and, consequently, of the overall composite material) beyond the sizes allowable by the conventional vapor deposition wafers, and, also, for compatibility/straightforward incorporation of the IR-reflecting layer deposition step into industrially-relevant instruments and fabrication processes, such as, for example, conventional roll-to-roll systems. In many embodiments, the flexible substrate comprises foil, such as, for example, aluminum foil. In many embodiments, the flexible substrate comprises any suitable (e.g., sufficiently smooth) common plastic or rubber. In many embodiments, the flexible substrate comprises any material or a combination of materials suitable for depositing (growing) columnar nanostructures comprising the IR-reflecting material and subsequent successful delamination, as described herein. In many embodiments, the flexible substrate comprising flexible foil, such as, for example, Al-foil, or another smooth flexible material, is an advantageous implement in the scale up of the manufacturing of the thermoregulating composite materials due to low cost of such substrates, and their compatibility with conventional roll-to-roll manufacturing systems. In addition, in many embodiments, the deposition substrates comprising flexible smooth materials allow for facile, clean, and reliable delamination of the thermoregulating composite material post-fabrication. Furthermore, in many embodiments, the flexible substrate is characterized by a low surface roughness Root Mean Square (RMS) value of <1 μm, wherein a higher roughness of the flexible substrate's deposition surface negatively affects the uniformity of the composite material's IR-reflecting layer (affecting both its planar and nanostructured components) and, consequently, influences the thermoregulating performance of the composite material. For example, deposition of the IR-reflecting layer onto certain exceedingly rough elastomeric surfaces may result in a non-uniform IR-reflecting nanostructures and poorly thermoregulating composite materials. Accordingly, in many embodiments, the resulting IR-reflecting layer atop the flexible, smooth, deposition substrate is relatively uniform, as illustrated, for example, by the digital camera pictures and corresponding SEM images provided in FIGS. 2B and 2C.

In many embodiments, next, to fabricate the overall thermoregulating composite material, the elastomeric matrix comprising an infrared-transparent polymer is coated directly onto and over the flexible substrate-bound nanostructured IR-reflecting layer as illustrated, for example, in FIG. 2D. In many embodiments, the coating is achieved by one of the techniques selected from the group consisting of: spray-coating, spin-coating, doctor blading, knife coating, slot-die coating, any other solution-based or neat material coating technique, and any combination thereof. In many embodiments, the thickness of the elastomeric matrix is 30 to 40 μm. In many embodiments, the IR-reflecting polymer is selected from the group consisting of: styrene-ethylene-butylene-styrene (SEBS) polymers, including various SEBS blends and blends of SEBS with polyethylene (PE) and high density polyethylene (HDPE), polydimethylsiloxane (PDMS), and any combination thereof. In many embodiments, the fabrication of the thermoregulating composite material is finalized by solvent evaporation (if any) and delamination of the resulting composite (comprising the planar IR-reflecting layer attached to the elastomeric matrix via the embedding nanostructured IR-reflecting layer) from the underlying flexible substrate, as illustrated, for example, in FIG. 2D. In many embodiments, the solvent evaporation/removal is conducted in such a way as to prevent polymer curing (i.e., chemical changes to the polymer). In many embodiments, the resulting, free-standing thermoregulating composite material film features the IR-reflecting (e.g., metal) surface fractured (but relatively uniform) into a plurality of IR-reflecting domains overlaying the IR-transparent elastomeric matrix, as illustrated, for example, by FIG. 2D (right), the digital camera images of the composite material film provided in FIG. 2E, and the corresponding SEM images provided in FIG. 2F.

Notably, according to many embodiments, the nanostructured component of the IR-reflecting layer of the composite material reliably embeds and attaches the planar component of the IR-reflecting layer to the elastomeric matrix, and, as such, ensures facile and clean delamination of the composite material from the fabrication process's substrate. For example, FIG. 2G illustrates that a composite material fabricated to only have the planar component of the IR-reflecting layer (Cu in this particular example), without the matrix embedding nanostructured component, could not be completely delaminated from the support substrate, wherein the delamination process afforded a material with millimeter-scale defects. Moreover, FIG. 2H further illustrates the strength and persistence of the elastomeric matrix embedding afforded by the nanostructured component of the IR-reflecting layer, wherein the embedded columnar nanostructures of the IR-reflecting material remain present within the elastomeric matrix after the planar component of the IR-reflecting layer is removed via a chemical treatment.

Furthermore, in many embodiments, the thickness of the planar component of the IR-reflecting layer also affects the results of the composite material's delamination from the fabrication support (i.e., the morphological characteristics of the resulting composite materials), and, as such, the thermoregulating performance of the resulting composite material. More specifically, in many embodiments, the composite materials with the planar component of the IR-reflecting layer having a thickness of 10 nm or less, such as, for example, 5 nm or 10 nm, are easily damaged during delamination from the fabrication support, presumably, although not to be bound by any theory, due to incomplete delamination, resulting in defects in the IR-reflecting surface, as can be seen, for example, in FIGS. 21 and 2J. On the other hand, in many embodiments, wherein the planar component of the IR-reflecting layer of the composite material has a thickness of 20 to 50 nm, few-to-no defects are observed in the delaminated, free standing film of the composite material, presumably, although not to be bound by any theory, due to optimal delamination from the fabrication support, as can be seen, for example, in FIGS. 2I and 2J. Furthermore, delamination from the fabrication support of the composite materials with the planar layer component of the IR-reflecting layer having a thickness equal to or more than 50 nm, such as, for example, 50 nm or 100 nm, produces IR-reflecting domains with raised edges, presumably, although not to be bound by any theory, due to partial debonding of the IR-reflecting material (e.g., metal), as can be seen, for example, in FIGS. 2I and 2J.

In many embodiments, the thickness of the planar component of the IR-reflecting layer also affects the size of the IR-reflecting domains formed upon delamination of the composite material from the fabrication support. More specifically, in many embodiments, the thinner is the planar component of the IR-reflecting layer of the composite material, the smaller are the IR-reflecting domains afforded by the delamination step of the composite material's fabrication process. Even more specifically, in many embodiments, the widths of the IR-reflecting domains on the surface of the instantly described composite materials increases almost linearly with the thickness of the planar component of the IR-reflecting layer, in agreement with theories developed for fracturing of thin metal films on polymers, as explained, for example, in: Wheeler, D. R. & Osaki, H. in Metallization of Polymers (eds Sacher, E. et al.) 500-512 (ACS Symposium Series 440, Washington D.C., 1990); and Arafat, Y., et al. On the deformation mechanisms and electrical behavior of highly stretchable metallic interconnects on elastomer substrates. J. Appl. Phys. 120, 115103 (2016), the disclosures of which are incorporated herein by reference. For example, as illustrated by FIGS. 2I and 2J, the composite materials with 5 nm and 10 nm-thick planar components (here, Cu) feature smaller IR-reflecting domains (as well as some defects, as discussed above), than the otherwise equivalent composite materials with a 20 nm-thick planar component. In turn, the same figures illustrate that the composite materials with 50 nm and 100 nm-thick planar components feature larger IR-reflecting domains (with raised edges, as discussed above) than the otherwise equivalent composite materials with a 20 nm-thick planar component. Furthermore, as another example, the quantitative evaluation of the sizes of the IR-reflecting domains overlaying the surface of the composite materials with varying thickness of the planar component of the IR-reflecting layer (Cu in this example) with the help of an image processing software, as illustrated in FIG. 2K, afforded the following IR-reflecting domain width data (regardless of the applied strain): ˜20 μm, ˜22 μm, ˜33 μm, ˜55 μm, and ˜68 μm for the planar component thicknesses of 5 nm, 10 nm, 20 nm, 50 nm, and 100 nm, respectively (FIG. 2L).

It should also be noted that, in many embodiments, the overall surface coverage of the composite material by the IR-reflecting domains upon extension of the elastomeric matrix also scales with the size of the IR-reflecting domains (which, in turn, scales with the thickness of the planar component of the IR-reflecting layer as explained above). More specifically, as illustrated by FIG. 2M, which presents image processing software-assisted quantification (FIG. 2K) of the average surface coverage afforded by the IR-reflecting domains at different strains applied to the composite material samples with varying thicknesses of the planar component of the IR-reflecting layer, at 0% strain, the average surface coverage by the IR-reflecting material is almost absolute (>˜95%) for all tested samples, regardless of their respective planar component's thickness. However, upon application of strain to the composite material (i.e., stretching), the coverage decreases monotonically for all samples, but to a different extent, depending on the thickness of the planar component of the IR-reflecting layer/size of the IR-reflecting domains, reaching values of ˜69%, ˜62%, ˜59%, ˜57%, and ˜54% for planar component's thicknesses of 5 nm, 10 nm, 20 nm, 50 nm, and 100 nm, respectively, at 100% strain (FIG. 2M).

In many embodiments, the entire fabrication procedure protocol described herein can be completed with high throughput within a few hours by minimally trained personnel from inexpensive starting materials. In many embodiments, the methods described herein allow to reliably fabricate free-standing composite materials with continuous total area as large as ˜570 cm² or larger. In some embodiments, the fabrication of thermoregulating composite materials according to the methods described herein costs as little as US$ 0.1 per 1 m² of the composite materials.

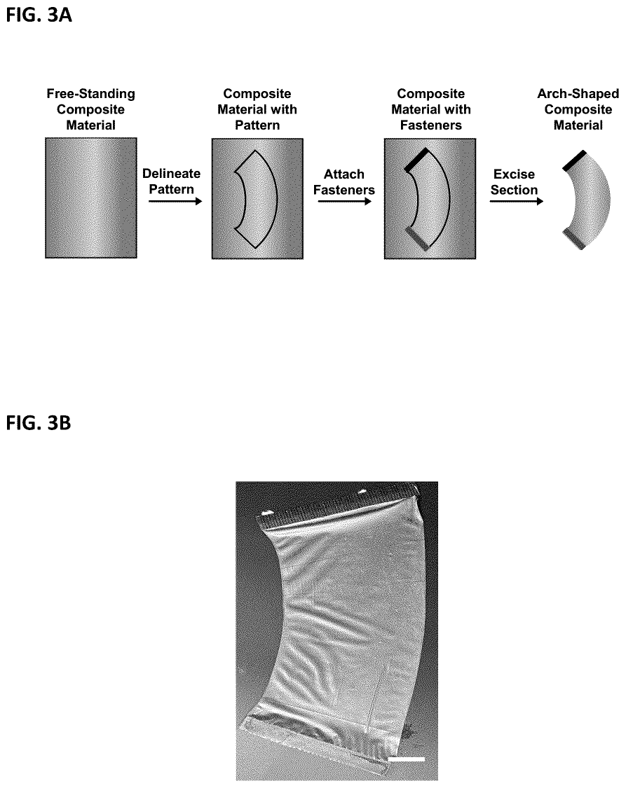

In many embodiments, the thermoregulating composite material is manufactured to cover a large-area of any desirable form factor or shape. In many embodiments, the thermoregulating composite materials is first manufactured in the convenient format of rectangular sheets, or any other convenient and or practical geometry, and then its geometry is altered as needed for incorporation into parts of any desirable size, shape, and form. For example, FIG. 3A illustrates the fabrication process, with FIG. 3B providing a digital camera image of its product, for a continuous large area, arch-shaped part comprising the thermoregulating composite material. Accordingly, in many embodiments, to prepare thermoregulating composite material parts of a desired size, shape, and or form, a pattern of the desired shape is cut out from the thermoregulating composite material of any other, prefabricated, shape that may simplify and standardize the fabrication of the thermoregulating composite material. More specifically, for example, the arch shape illustrated in FIGS. 3A and 3B was first delineated/drawn on one side of a pre-fabricated, free-standing rectangle of the thermoregulating composite material, and then excised from the provided material. In some embodiments, the thermoregulating composite material part is further decorated with any desired elements, such as, for example, fasteners, or control elements, on any of its sides or ends, pre- or post-excision from a larger piece of the composite material. For example, the part illustrated in FIGS. 3A and 3B, features hook and loop fasteners added pre-excision from a larger rectangle of the thermoregulating composite material via an adhesive, such as to furnish a ‘cozy-like’ system suitable for thermoregulation of a paper cup to enhance the beverage consumption experience (such as described, for example in Pramudya, R. C., et al. “Bitter touch”: cross-modal associations between hand-feel touch and gustatory cues in the context of coffee consumption experience. Food Qual. Prefer. 83, 103914 (2020), the disclosure of which is incorporated herein by reference).

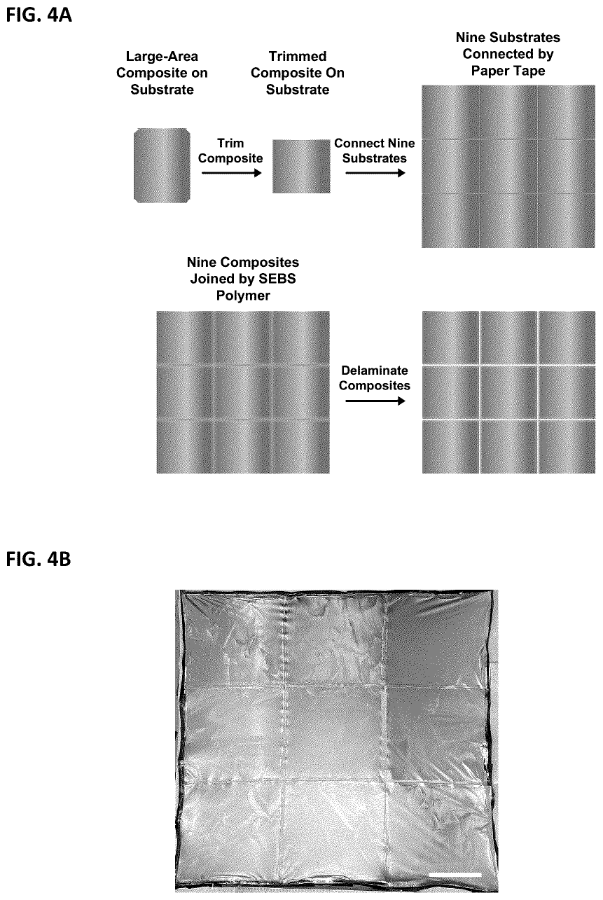

In addition, in some embodiments, a part of any desired size and shape, wherein the part comprises the thermoregulating composite material, is obtained by joining multiple smaller pieces comprising the same. As another illustrative example, FIG. 4A illustrates the fabrication process, with FIG. 4B providing a digital camera image of a representative product, that can be used to obtain a thermoregulating composite material part in a large blanket/sheet configuration, wherein the blanket comprises smaller rectangles of the thermoregulating composite material joined together according to the methods described herein. More specifically, in some embodiments, to prepare a larger size, thermoregulating composite material part of a desired shape, two or more conveniently pre-fabricated pieces of the thermoregulating composite material are first obtained as is, or trimmed as necessary post-fabrication, and, then, joined to create the desired shape using the elastomeric matrix polymer as a non-interfering “glue.” In some embodiments, for the joining step of the fabrication process, the pieces to be joined remain attached to the flexible substrate for easier handling—i.e., they are obtained and or excised from the pre-fabricated rolls/sheets prior to the delamination step. As shown in FIG. 4A, according to such joining methods, a larger blanket comprising the thermoregulating composite material may be obtained from, for example, nine conveniently pre-fabricated smaller rectangles of the thermoregulating composite material. In this particular example illustrating some embodiments, the smaller rectangles of the thermoregulating composite material were first fabricated according to the methods described herein, then trimmed to the desired size prior to their delamination from the flexible foil substrate used in their production (i.e., while still foil substrate-bound), and then connected with adhesive tape applied to their flexible substrate side, such as to create narrow gaps between the edges of the smaller rectangles comprising the thermoregulating composite material. Notably, in many embodiments, the gaps may be less than 1 mm wide. However, in some embodiments, the gaps may be less than 1 cm wide. Next, the gaps were filled with syringe-cast solution of the same polymer as used for the elastomeric matrix polymer, and the overall assembly allowed to dry, to, de facto, glue the desired blanket together. Finally, the assembled blanket was delaminated from the foil support to produce a single, free-standing, large area thermoregulating sheet (FIG. 4B). Accordingly, in many embodiments, the methods and procedures described herein may furnish ‘quilt-like’ systems with areas as large as ˜3,480 cm² (FIG. 4B), or larger, which compares favorably with the areas of metallized films used in heat-managing packaging, and greatly exceeds (by as much as >20-fold) the coverage capabilities of many thermoregulating composite materials reported to date. In many embodiments, the methods for fabrication of parts comprising the thermoregulating composite materials described herein, including excision and robust joining of shapes obtained from conveniently pre-fabricated rolls/sheets, offer unlimited versatility, modularity and scalability for heat regulation over large areas of any desired shape and form.

Properties of the Thermoregulating Composite Materials Fabricated to have Large Areas

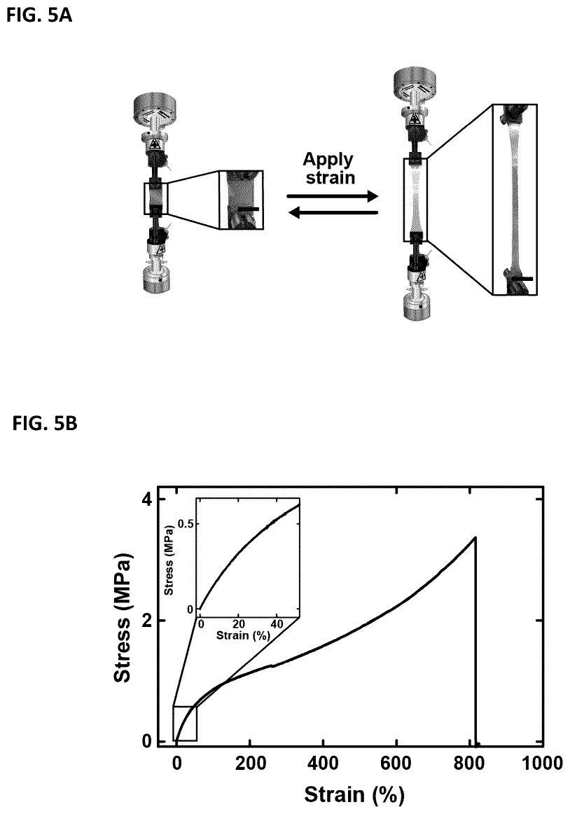

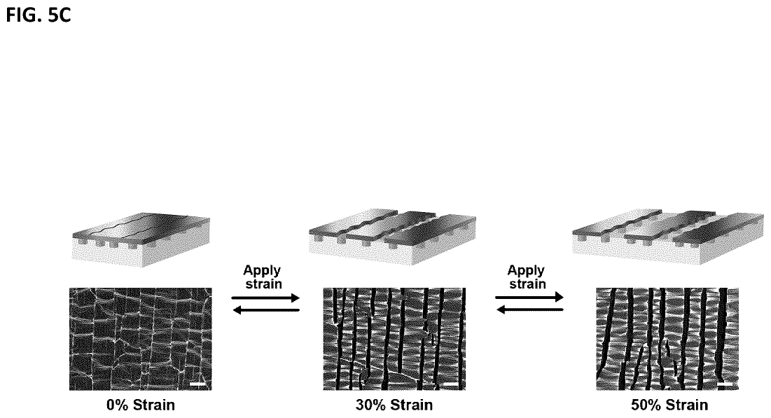

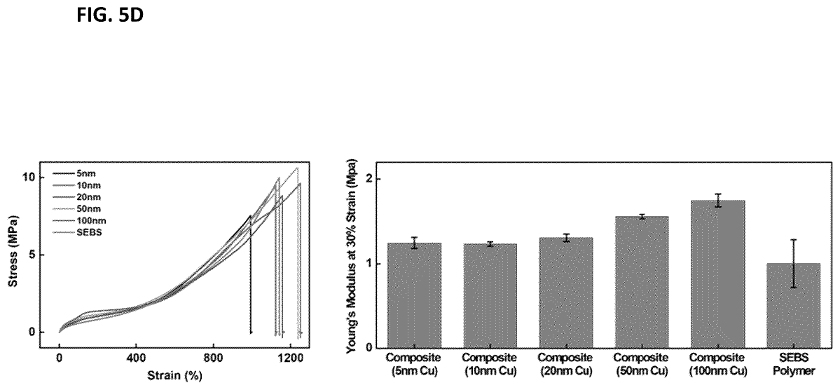

In many embodiments, the thermoregulating composite materials fabricated according to the methods and procedures of the instant disclosure possess excellent mechanical properties. As an illustrative example, FIG. 5A provides digital camera images of a representative experiment conducted to test the tensile strength of the thermoregulating composite material, while FIG. 5B shows a representative quantification of such tests—an engineering stress versus strain curve. In addition, FIG. 5C (as well as FIG. 2J) provides representative SEM images obtained for the thermoregulating composite materials at different applied strains. Accordingly, in many embodiments, the thermoregulating composite materials of the instant disclosure readily withstand substantial deformation, with Young's moduli ranging from 1.3-2.0 MPa, and breaking strains ranging from 600 to 1,500%. In many embodiments, the thermoregulating composite materials are characterized by Young modulus of ˜1.8±0.1 MPa and breaking strain of ˜810±10% (FIGS. 5A through 5D). More specifically, in many embodiments, upon application of strain, the surface of the thermoregulating composite materials transitions from a nearly continuous infrared-reflecting metal layer comprising closely abutting IR-reflecting (e.g., metal) domains (which completely cover the underlying IR-transmitting elastomeric matrix) to a fractured IR-reflecting layer consisting of separated IR-reflecting domains (which partially expose the IR-transmitting elastomeric matrix), as illustrated by FIGS. 5C and 2J. In many embodiments, the strain-reconfigurable morphologies and beneficial mechanical characteristics of the thermoregulating composite materials are maintained upon scaling of the composite material's size. As such, in many embodiments, the thermoregulating composite materials and parts comprising thereof fabricated according to the methods and processes of the instant disclosure exhibit robust and consistent adaptive infrared-reflecting behavior, as well as good mechanical stability, at any size.

In addition, it should be noted, that according to many embodiments, the thickness of the planar component of the IR-reflecting layer and, as such, the size of the IR-reflecting domains of the composite materials weakly affect the mechanical properties of the composite materials, although the mechanical properties are primarily dictated and dominated by the underlying elastomeric matrix. For example, FIG. 5D, illustrates that, for the composite materials with Cu as the IR-reflecting layer, elongation to break and Young's moduli are affected somewhat by the increased thickness of the planar component of the IR-reflecting layer.

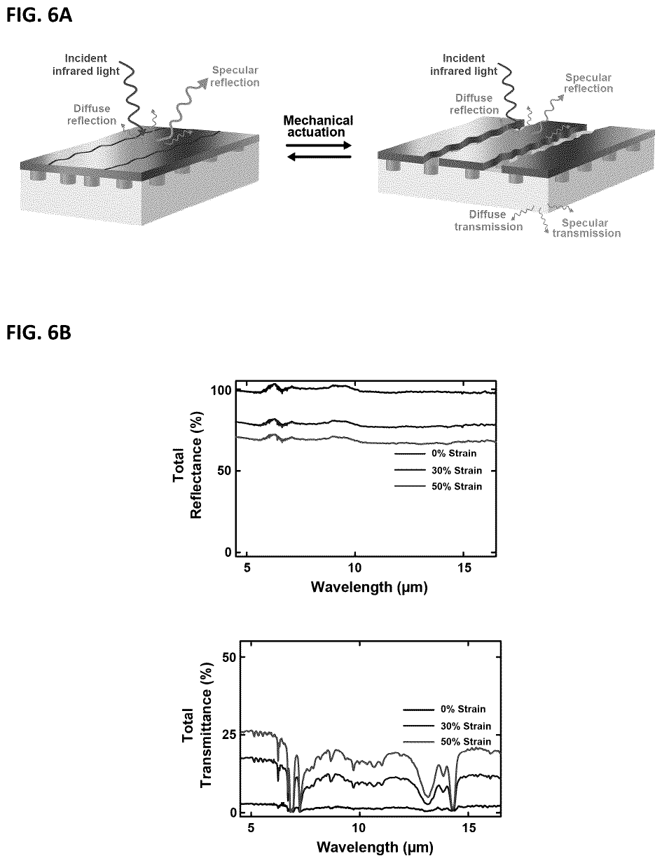

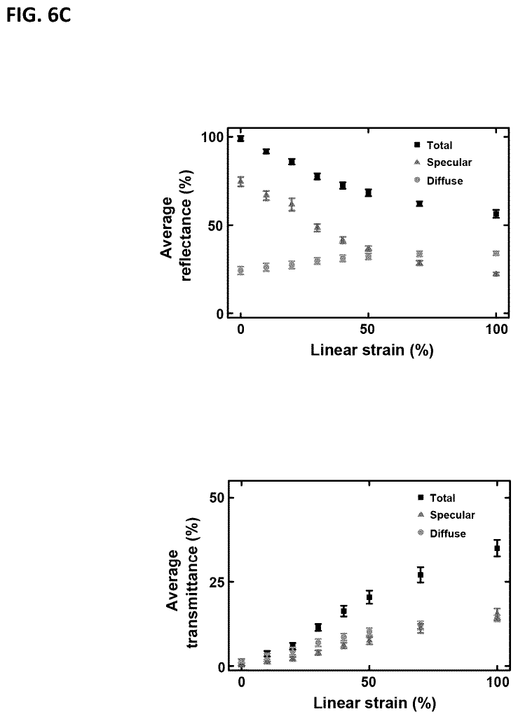

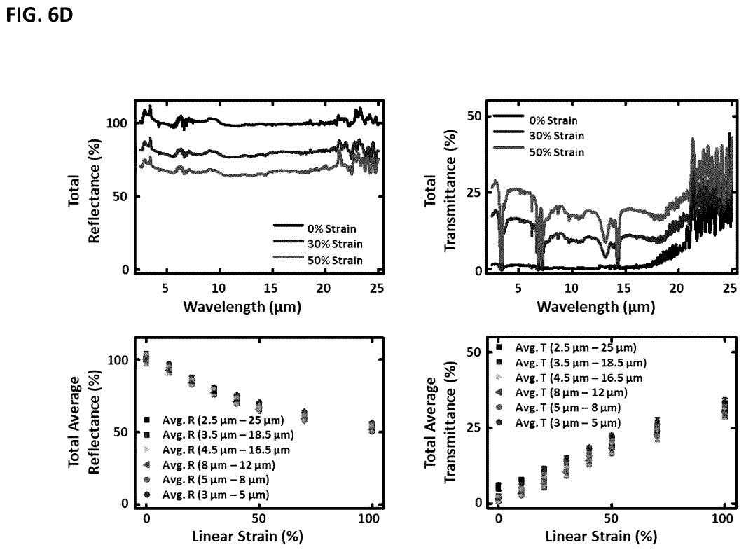

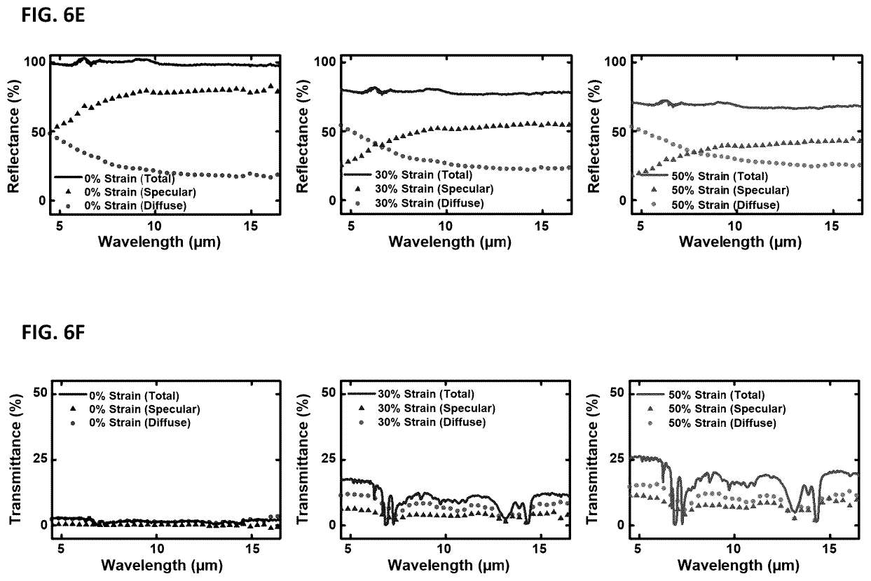

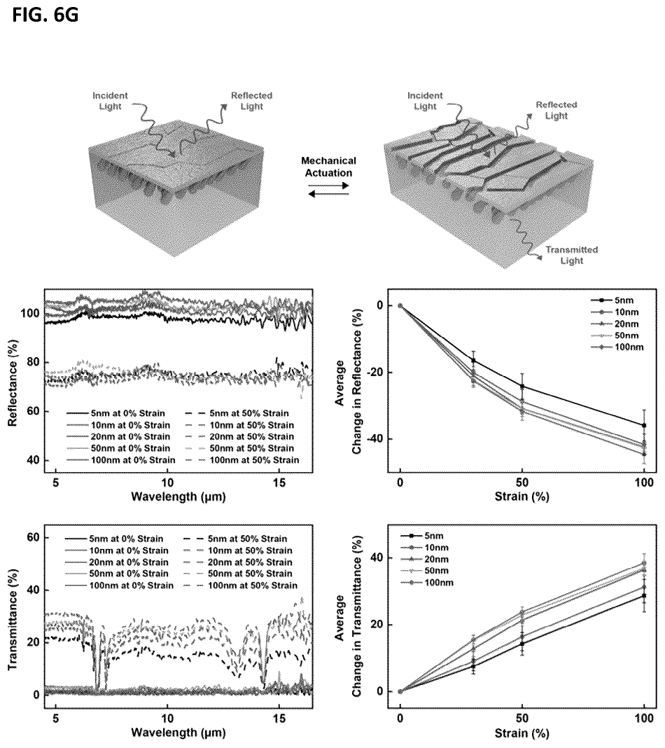

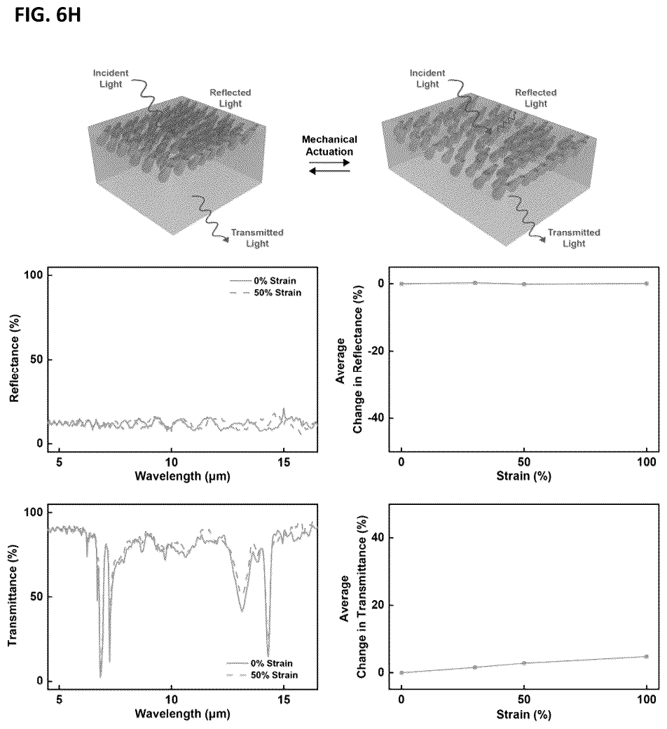

In many embodiments, the thermoregulating composite materials reflect and transmit incident light within the mid-infrared region of the electromagnetic spectrum as illustrated by FIGS. 6A and 6G (top) and relevant representative data provided in FIGS. 6B through 6G. More specifically, FIG. 6B provides representative total infrared reflectance (top) and total transmittance (bottom) spectra obtained at different strains for a representative sample of the thermoregulating composite material comprising Cu as the IR-reflecting layer (planar and nanostructured components) and SEBS as the elastomeric matrix, and having an overall thickness of 30 μm-35 μm; while FIG. 6C provides the corresponding average values calculated from these spectra (top and bottom, respectively). As can be seen from the presented data, and according to many embodiments, in absence of any strain (i.e., applied strain is 0%), the thermoregulating composite materials demonstrate high total reflectance of ˜99±1% (FIG. 6B, top) and low total transmittance of ˜2±1% (FIG. 6B, bottom). However, according to the presented data, applying a 30% strain to the thermoregulating composite materials decreases their total reflectance to ˜78±2% (FIG. 6B, top), and increases its total transmittance to ˜11±1% (FIG. 6B, bottom). Moreover, according to the same data, further increasing the applied strain to 50%, further decreases total reflectance of the thermoregulating composite materials to ˜68±2% (FIG. 6B, top), and further increases its total transmittance to ˜20±1% (FIG. 6B, bottom). Accordingly, in many embodiments, the general trends in IR-reflectance and IR-transmittance properties of the thermoregulating composite materials described herein remain consistent for strains of ≤100%, as illustrated by FIG. 6C. Notably, in many embodiments, the thermoregulating composite materials demonstrate excellent thermoregulating performance over broad mid-infrared range of the electromagnetic spectrum, indicating nearly optimal reflectance and transmittance switching ratios of ˜2 and ˜23, respectively, for the 4.5-16.5 μm wavelength range (FIG. 6D). In many embodiments, the thermoregulating composite materials demonstrate excellent adaptive functionality over large area and across the entire mid-infrared range of the electromagnetic spectrum, which encompasses the technologically valuable atmospheric transmission windows.

In many embodiments, the thermoregulating composite materials also reflect incident light within the infrared range of the electromagnetic spectrum (4.5-16.5 μm) specularly and diffusely (FIG. 6A). For example, FIG. 6E provides representative specular and diffuse infrared reflectance spectra obtained at various strains for a sample of the thermoregulating composite material comprising Cu as the IR-reflecting layer (planar and nanostructured components) and SEBS as the elastomeric matrix, and having an overall thickness of 30 μm-35 μm; while the corresponding average values calculated from these spectra are shown in FIG. 6C (top). More specifically, the data indicates that, in many embodiments, in absence of any strain (i.e., applied strain is 0%), the average specular and diffuse components of the reflectance by the thermoregulating composite materials is ˜75±3 and ˜24±2%, respectively (FIG. 6E, left). However, according to this representative data, applying strain of 30% to the thermoregulating composite material decreases the specular component of its reflectance to ˜49±2%, but increases the diffuse component to ˜30±2% (FIG. 6E, middle). Furthermore, increasing the applied strain to 50%, further decreases the specular component of the composite materials' reflectance to ˜37±2%, and slightly increases the diffuse component to ˜32±2% (FIG. 6E, right). In many embodiments, the general trends for the specular and diffuse reflectance components of the thermoregulating composite materials' IR-reflectance described herein are maintained for applied strains of ≤100% (FIG. 6C, top). Accordingly, although not to be bound by any theory, in many embodiments, the total IR-reflectance of the thermoregulating composite materials changes because of a systematic strain-induced reduction of the specular component (i.e., the direct reflection from the fractured metal layer), and a concomitant strain-induced enhancement of the diffuse component (i.e., the indirect scattering by the metal domains), as illustrated in FIG. 6A.

In many embodiments, the thermoregulating composite materials also transmit incident light within the infrared range of the electromagnetic spectrum (4.5-16.5 μm) specularly and diffusely, as illustrated in FIG. 6A. For example, FIG. 6F provides representative specular and diffuse infrared transmittance spectra obtained at various strains for a sample of the thermoregulating composite material comprising Cu as the IR-reflecting layer (planar and nanostructured components) and SEBS as the elastomeric matrix, and having an overall thickness of 30 μm-35 μm; while the corresponding average values calculated from these spectra are shown in FIG. 6C (bottom). More specifically, in many embodiments, in absence of any strain (i.e., an applied strain is 0%), the average specular and diffuse components of the thermoregulating composite material's transmittance are ˜0±0 and ˜2±1%, respectively (FIG. 6F, left). However, according to this representative data, applying strain of 30% to the thermoregulating composite material, somewhat increases the specular and diffuse components of the composite material's transmittance to ˜4±1 and ˜7±1%, respectively (FIG. 6F, middle). Furthermore, according to the data, increasing applied strain to 50%, further increases specular and diffuse components of the transmittance by the composite material to ˜9±1 and ˜11±1%, respectively (FIG. 6F, right). In many embodiments, the general trends for the specular and diffuse components of the IR-transmittance by the thermoregulating composite materials described herein are maintained for applied strains of ≤100% (FIG. 6C, bottom). Accordingly, although not to be bound by any theory, in many embodiments, the total IR-transmittance of the thermoregulating composite materials changes because of a systematic strain-induced enhancement in both the specular component (i.e., direct transmission by the stretched elastomeric matrix) and the diffuse component (i.e., indirect scattering by the metal domains and or the elastomeric matrix), as illustrated in FIG. 6A.

In addition, it should be noted that, in many embodiments, the IR-reflecting and transmitting properties of the thermoregulating composite materials are affected by the thickness of the planar component of their IR-reflecting layer. For example, FIG. 6G. illustrates (top) and provides data (middle and bottom) for a series of experiments, wherein the total reflectance (middle, left) and transmittance (bottom, left) spectra were obtained for unactuated (0% strain) and actuated (50% strain applied) representative samples of the composite materials with variable thickness of the planar component of their IR-reflecting layer (Cu in these experiments). In addition, FIG. 6G also provides the corresponding calculated changes in the average measured reflectance and transmittance. As can be seen from this data, for the composite material samples with the thickness of the planar component of 5 nm and 10 nm, the average total reflectance values were found to be ˜98±4% and ˜101±3%, respectively, at 0% strain, which decreased to ˜74±2% and ˜73±4%, respectively, at 50% strain (FIG. 6G, middle, left). However, the composite material samples with thicker planar component of the IR-reflecting layer, i.e., with the planar component thicknesses of 20 nm, 50 nm, and 100 nm, demonstrated slightly larger average total reflectance values of ˜103±1%, ˜104±1%, and ˜104±4%, respectively, at 0% strain, which decreased to a slightly greater extent, to ˜72±2%, ˜72±2%, and ˜73±4%, respectively, at 50% strain (FIG. 6G, middle, left). Accordingly, in many embodiments, for the composite materials characterized by different thicknesses of the planar component of the IR-reflecting layer, the average change in their total reflectance progressively increases with the thickness of the planar component as a function of the applied strain, with the most substantial modulation observed for the composite materials with the thickest planar component of the IR-reflecting layer (FIG. 6G, middle, right). Furthermore, for the composite material samples with the thickness of the planar component of 5 nm and 10 nm, the average total transmittances were found to be ˜2±1% and ˜2 ±1%, respectively, at 0% strain, which increased to ˜16±2% and ˜18±4%, respectively, at 50% strain (FIG. 6G, bottom, left). On the other hand, the composite material samples with thicker planar component of the IR-reflecting layer, i.e., with the planar component thicknesses of 20 nm, 50 nm, and 100 nm, demonstrated similar average total transmittances of ˜1±1%, ˜2±1%, and ˜3±2%, respectively, at 0% strain, which increased to a significantly larger extent, to ˜23±2%, ˜24±1%, and ˜26±2%, respectively, at 50% strain (FIG. 6G, bottom, left). Accordingly, in many embodiments, for the composite materials characterized by different thicknesses of the planar component of the IR-reflecting layer, the average change in their total transmittance progressively increases with the thickness of the planar component as a function of the applied strain, with the largest modulation, again, observed for the composite materials with the thickest planar component of the IR-reflecting layer (FIG. 6G, bottom, right). In many embodiments, these observed trends, presumably, although not to be bound by any theory, are a result of the relatively larger surface coverage changes at strain afforded by larger IR-reflecting domains of the composite materials with thicker planar components of the IR-reflecting layer, as discussed above and illustrated by FIGS. 2J and 2M. Notably, the average reflectance and transmittance remain relatively unchanged, regardless of the applied strain, for the composite material with removed planar component of the IR-reflecting layer, as illustrated by FIG. 6H, which further underscores the critical role of the planar component of the IR-reflecting layer in the thermoregulating properties of the composite materials described herein.

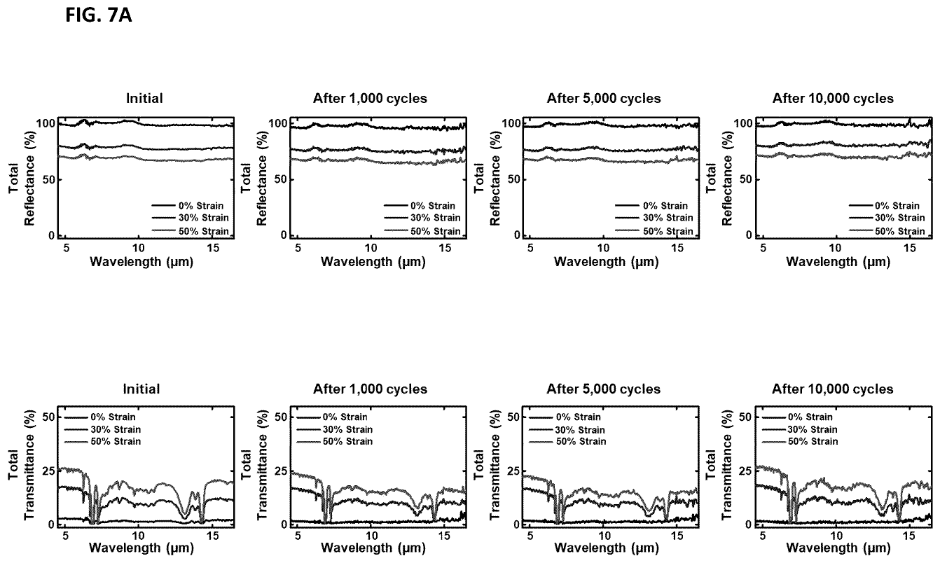

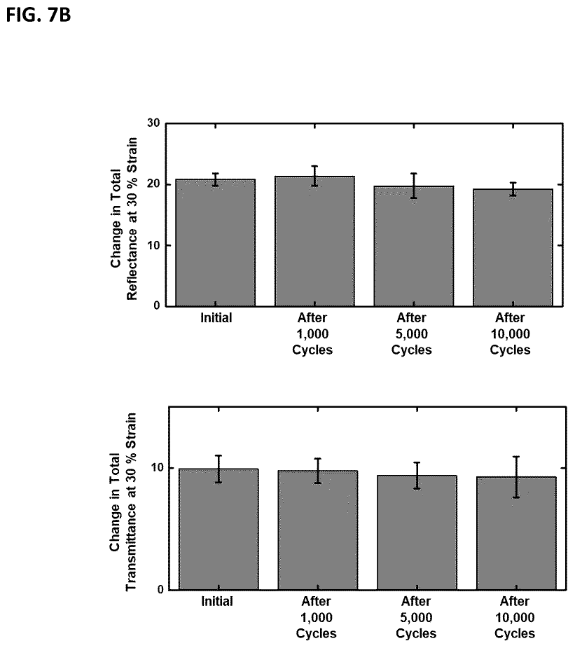

In many embodiments, the thermoregulating composite materials and parts manufactured according to the instantly disclosed methods are stable and withstand subjection to repeated mechanical actuation (strain) very well. For example, FIGS. 7A and 7B illustrate the robustness of the thermoregulating composite materials by providing representative total infrared reflectance (FIG. 7A, top) and transmittance (FIG. 7A, bottom) spectra for the composite material of the instant disclosure after different numbers of strain cycles, as well as the corresponding calculated cycling-induced changes in the reflectance (FIG. 7B, top) and transmittance (FIG. 7B, bottom). More specifically, the provided data shows that, upon the first application of strain of 30% (first cycle), the average reflectance of the composite material decreases by ˜21±1% and its average transmittance increases by ˜10±1%. Furthermore, according to this data, and many embodiments, the composite material continues to yield the exactly same average reflectance decrease and the average transmittance increase values (by ˜21±2% and by ˜10±1%, respectively) after 1,000 cycles of applying the same strain amount (FIG. 7A). In many embodiments, the thermoregulating composite materials maintain their performance (i.e., the changes in reflectance and transmittance remain comparable) after 1,000, 5,000, and even 10,000 total strain cycles (FIG. 7B). In some embodiments, the functional stability of the thermoregulating composite materials fabricated to large scale according to the methods disclosed herein outperforms and exceeds the functional stability of many other thermoregulating composite materials prepared by other techniques, and or according to different component parameters, by as much as tenfold. Accordingly, in many embodiments, the thermoregulating composite materials prepared according to the instant methods and procedures allow for robust thermoregulation over large areas, and can withstand repeated mechanical strain, which makes them very advantageous materials for a variety of practical applications, including packaging and clothing applications.

### Dynamic Heat-Management Properties of the Large-Area Thermoregulating Composite Materials

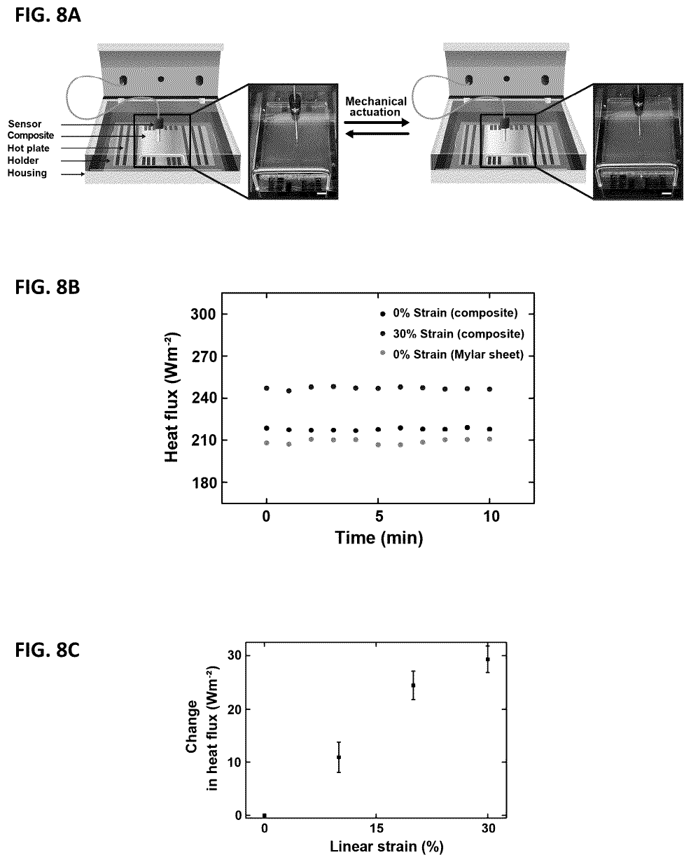

In many embodiments, the heat-management capabilities of the thermoregulating composite materials fabricated according to the methods of the instant disclosure, are tunable, i.e., real-time adjustable. For example, FIGS. 8A through 8C illustrate such capabilities of a swath of the thermoregulating composite material placed over a guarded hot plate, and compare them to the capabilities of an equivalent swath of a common metallized polymer (Mylar™) subjected to equivalent testing conditions. Here, the metallized polymer material represents the “space blanket” technology (such as described, for example, in: Chadwick, S.; Gibson, A. Hypothermia and the use of space blankets: a literature review. Accid. Emerg. Nurs. 5, 122-125 (1997); Reflecting on Space Benefits: A Shining Example. Spinoff 2006 (NASA, 2006); https://spinoff.nasa.gov/Spinoff2006/ch_9.html; and Kranebitter, H.; et al. Rescue blankets-transmission and reflectivity of electromagnetic radiation. Coatings 10, 375 (2020), the disclosures of which are incorporated herein by reference), commonly used for static heat management, wherein this technology can only block heat passage, without any gradient to its capabilities once applied. To this end, FIG. 8A provides illustrations and digital camera images of the relevant experimental testing setup, while FIGS. 8B and 8C provide representative time-dependent heat flux data, and calculated average heat flux change data, respectively, obtained for the tested materials. As such, the thermal measurements for a swath of the thermoregulating composite material indicated the heat flux change from ˜214 to ˜244 W m⁻² in response to the application of a 30% strain (FIG. 8B). In contrast, the same thermal measurements for the representative metallized polymer sheet afforded a heat flux of ˜210 W m⁻², which could not be modulated/changed by the same moderate 30% strain (FIG. 8B). More generally, the heat flux changes observed for the tested thermoregulating composite materials increased from ˜11±3 W m⁻² to ˜22±3 W m⁻² to ˜29±3 W m⁻² upon actuation with increasing strain (from 0% to 10%, and 30%, strains, respectively) (FIG. 8C). Accordingly, in many embodiments, the large area, thermoregulating composite materials fabricated according to the methods of the instant application efficiently manage thermal fluxes of up to ˜30 W m⁻² with estimated mechanical power inputs of only ˜3 W m⁻². In some embodiments, the performance of the thermoregulating composite materials is similar to that of their analogs fabricated on small scale. In many embodiments, the large area thermoregulating composite materials fabricated according to the instant methods demonstrate the thermal properties of the “space blanket” under idealized conditions, yet also exhibit on-demand tunability of such thermal properties with minimal actuation energy input and excellent efficiency. In many embodiments, the thermoregulating composite materials possess an optimal set of features and desirable characteristics for packaging applications, including food and beverage packaging applications, or any other suitable applications, including clothing, clinical warming devices, and soft robotics.

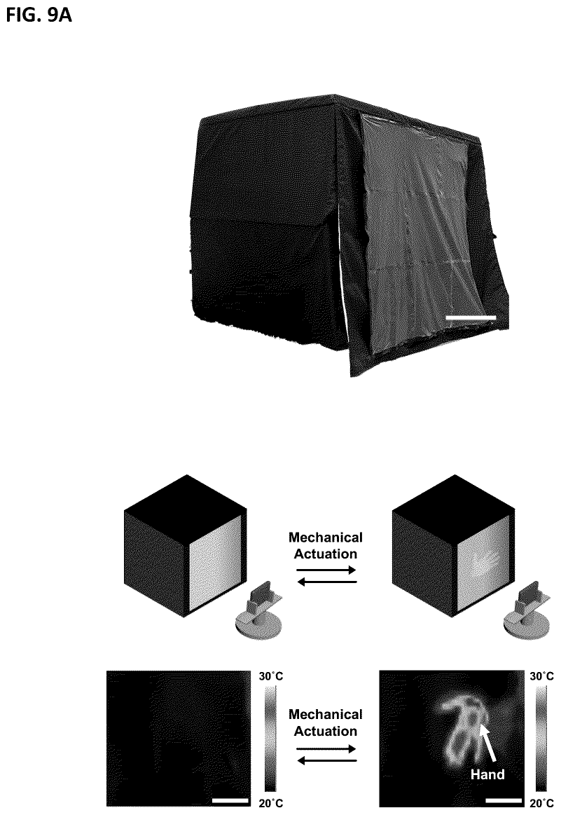

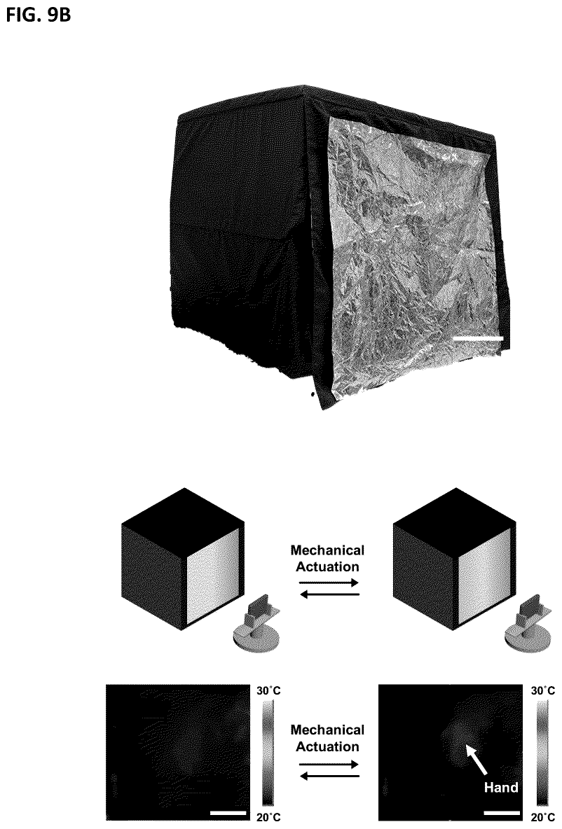

In some embodiments, the tunable heat-management capabilities of the large area thermoregulating composite materials fabricated according to the instant methods are well-suited for packaging applications. For example, images and data provided in FIG. 9A illustrate such potential applications, wherein a 24×22.5 inch rectangular, quilt-like sheet comprising nine thermoregulating composite material rectangles assembled according to the instant methods, is incorporated as one of the walls in a representative packaging box/enclosure (FIG. 9A, top). In this illustrative example, but also in many embodiments, the enclosure-integrated thermoregulating composite material quilt in its un-activated state (i.e., no strain is applied, FIG. 9A, middle, left) globally blocks the heat radiated by the enclosure's content (here, a heat radiating hand), such that, the uniform average apparent temperature of the quilt's external surface is comparable to that of the enclosure's external environment (˜20.4° C., in this particular experiment, FIG. 9A, bottom, left). However, in many embodiments, a mechanical deformation (e.g., stretching, here, by the enclosed hand) of the enclosure's surface comprising the thermoregulating composite material (FIG. 9A, middle, right) locally increases the apparent temperature of the stretched external surface to approach that of the temperature of the enclosure's content—e.g., the hand of the experiment in this illustrative example (FIG. 9A, bottom, right). This predictable, according to many embodiments, strain-variable behavior of the thermoregulating composite materials is in contrast to the behavior of a conventional metallized polymer material (i.e., the “space blanket”) under analogous tests conditions (FIG. 9B, top). More specifically, although the space blanket successfully blocks the hand-radiated heat (FIG. 9B, middle, left) as expected, such that the uniform average apparent temperature of the quilt's external surface measures at ˜20.8° C. (FIG. 9B, bottom, left), its mechanical deformation (FIG. 9B, middle, right) does not produce any noticeable change in the temperature of the space blanket's surface temperature (FIG. 9B, bottom, right). Notably, in many embodiments, the apparent temperature changes on the surface of the thermoregulating composite material parts incorporated, for example, into enclosures containing matter of a temperature different from that of the enclosure's external environment, remain consistent over multiple actuation cycles. Accordingly, in many embodiments, the thermoregulating composite materials, as well as parts and systems comprising thereof, are employed to dynamically modulate the exchange of heat between an environment and an object or matter having a temperature distinct from the environment in a robust, reliable, and consistent manner, wherein the modulation is achieved by mechanical actuation.

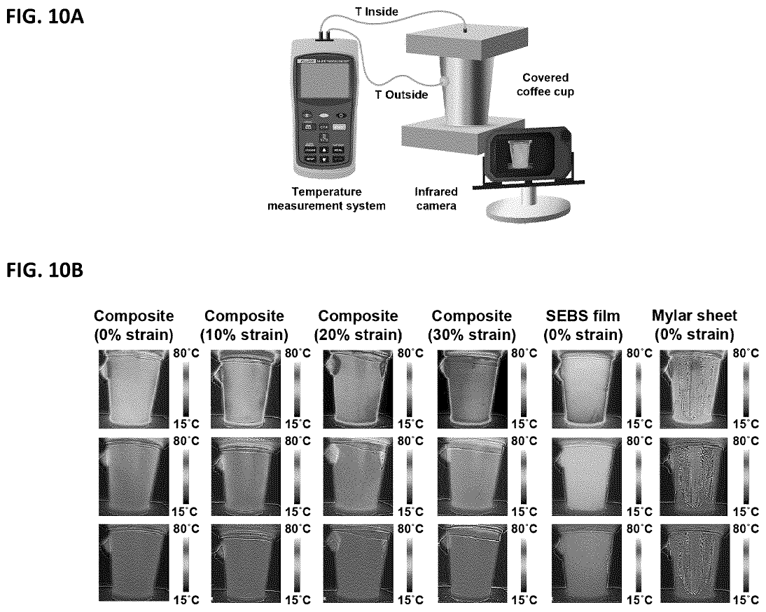

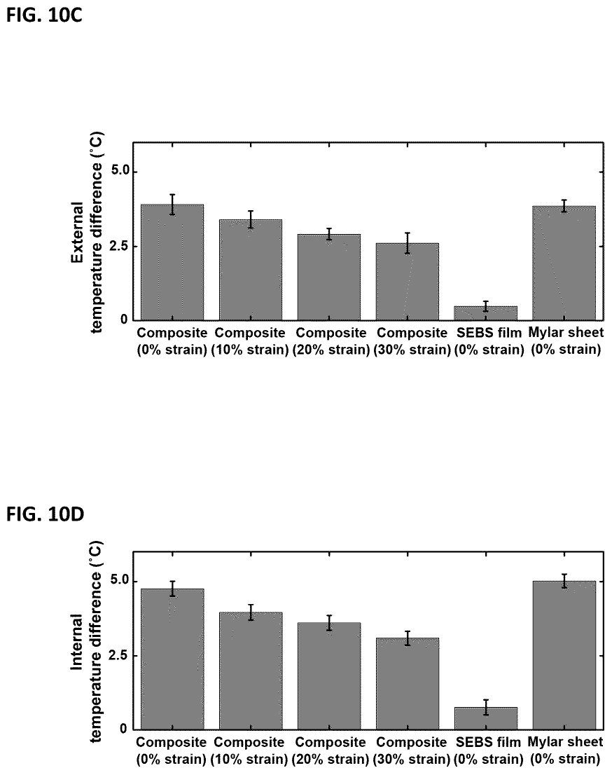

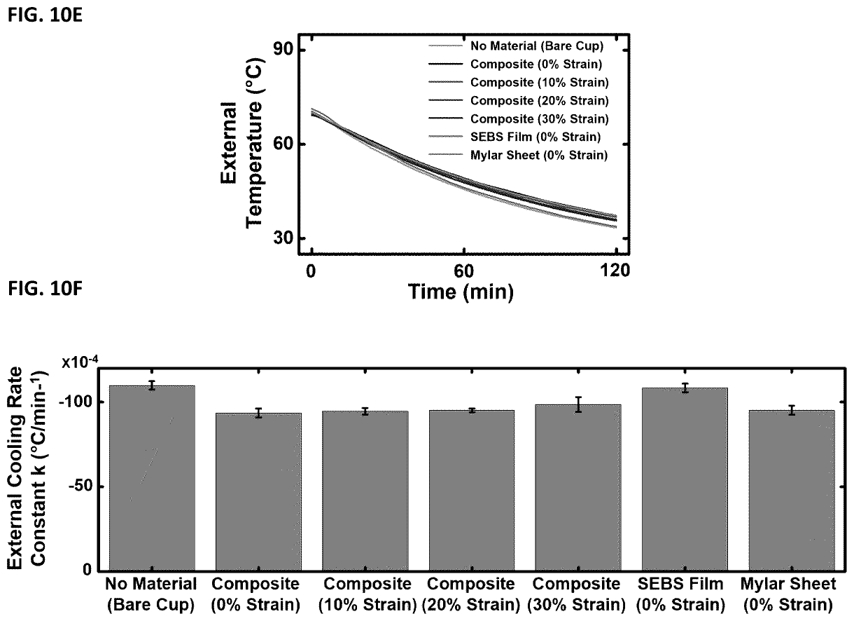

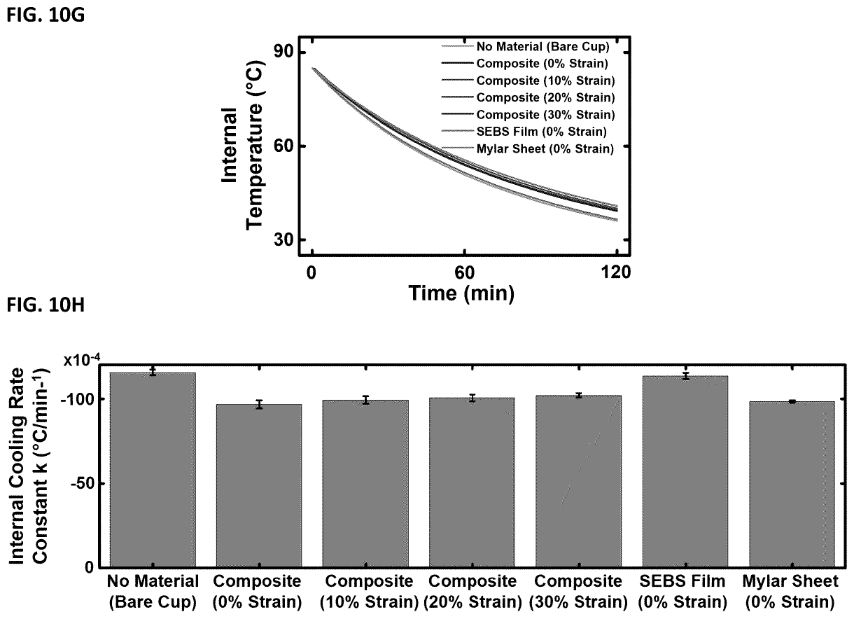

Furthermore, FIGS. 10A through 10H provide yet another illustrative example of the thermoregulatory capabilities of the thermoregulating composite materials and parts comprising thereof fabricated according to the instant methods. More specifically, FIGS. 10A through 10H illustrate the heat managing performance of a cup “cozy” comprising the thermoregulating composite material when wrapped around a hot beverage-filled, disposable paper cup, and compare it to the performances of a cozy comprising the elastomeric matrix alone, and, separately, a Mylar™ sheet. To this end, first, FIG. 10A illustrates the experimental cup system setup, while FIG. 10B provides the corresponding representative, time-lapse thermal infrared camera images obtained for hot coffee-filled cups wrapped in the cozies comprising one of the chosen materials (including the thermoregulating composite material at different applied strains) obtained at different lapsed times (i.e., at 0 hrs, 1 hr, and 1.5 hrs-top to bottom rows, respectively). Next, FIGS. 10C and 10D show, for each cup system provided in FIGS. 10B, the calculated difference in temperature (external and internal to the cup for each cup system, FIG. 10C and FIG. 10D respectively) between a cup wrapped in one of the materials listed in FIG. 10B, and an equivalent bare (i.e., uncovered by any material) cup standard at 90 minutes of the experiment. Furthermore, FIGS. 10E through 10H provide data for the temperatures and cooling rates measured for all the cup systems provided in FIG. 10B. Accordingly, as illustrated by the provided images and data, the external and internal temperatures dropped significantly (from 85° C. to the range of 30-40° C.) within 1-2 h of the experiment with the hot coffee-filled cup wrapped in the unactuated (0% applied strain) thermoregulating composite material (FIGS. 10B, 10E, and 10G), with calculated external and internal cooling rates of around −(93.5±2.6)×10⁻⁴ and −(96.7±2.3)×10⁻⁴° C. min⁻¹, respectively (FIGS. 10F and 10H). Notably, at 90 minutes, this cup system had external and internal temperatures that were, respectively, ˜3.9±0.3 and ˜4.8±0.3° C. higher than those of the bare cup standard (FIGS. 10C and 10D). As such, a hot liquid-containing paper cup wrapped in the thermoregulating composite material at 0% strain appears to stay warmer for a longer period of time than a comparable cup without such wrapper. Furthermore, the external and internal temperatures of the hot coffee-filled cup covered with the thermoregulating composite materials actuated with 30% strain dropped even faster within the same 1-2 h period (FIGS. 10B, 10E, and 10G), with external and internal cooling rates of around −(98.6±2.5)×10⁻⁴ and −(102.1±1.3)×10⁻⁴° C. min⁻¹, respectively (FIGS. 10F and 10H). Also, at 90 minutes, this cup system had external and internal temperatures that were, respectively, ˜2.6±0.3 and ˜3.1±0.2° C. higher than those of the bare cup standard (FIGS. 10C and 10D). Accordingly, in many embodiments, applying strain to the thermoregulating composite material wrapper/cozy reduces the difference between having and not at all having such a cozy, and the greater is the applied strain, the smaller is this difference. In general, the illustrative experiments described by FIGS. 10A through 10H indicate that, according to many embodiments, the heat regulating capabilities of the thermoregulating composite materials and parts scale well as a function of the applied strain. More specifically, as experimentally demonstrated here, and according to many embodiments, a heat management system for, for example, a hot liquid, wherein the system comprises, for example, a paper cup wrapped in the thermoregulating composite material of the instant application, the extent of the cooling, as well as the cooling rate, of the internal and the external surfaces of such cup system all increase as a function of the strain applied to the thermoregulating composite material cozy, while such cozy's advantage (over an uncovered cup) decreases as a function of the strain applied to the thermoregulating composite material.

In addition, to further emphasize the uniquely tunable heat management capabilities of the thermoregulating composite materials of the instant application, FIGS. 10A through 10H also provide data that allows to compare their performance to that of some other materials commonly employed in food and beverage packaging—a polymer film (here, SEBS, which also may be used as the elastomeric matrix of the thermoregulating composite materials), and a metallized polymer film (here, space blanket/Mylar™ material). To this end, the appropriate measurements indicated that, the external and internal temperatures dropped quickly within 1-2 h for the cup system comprising the SEBS polymer film (FIGS. 10B, 10E, and 10G), with calculated external and internal cooling rates of around −(108.3±2.5)×10⁻⁴ and −(113.6±1.8)×10⁻⁴° C. min⁻¹, respectively (FIGS. 10F and 10H). Furthermore, at 90 minutes, this cup system had external and internal temperatures that were, respectively, ˜0.5±0.2 and ˜0.4±0.2° C. higher than those of the bare cup standard (FIGS. 10C and 10D). Moreover, the external and internal temperatures dropped more slowly within 1-2 h for the cup system comprising the metallized polymer sheet (FIGS. 10B, 10E, and 10G), with calculated external and internal cooling rates of around −(95.9±2.6)×10⁻⁴ and −(98.5±0.7)×10⁻⁴° C. min⁻¹, respectively (FIGS. 10F and 10H). In addition, at 90 minutes, this cup system had external and internal temperatures that were, respectively, ˜3.9±0.2 and ˜5.0±0.3° C. higher than those of the bare cup standard (FIGS. 10C and 10D). Accordingly, these additional experiments further highlighted the unique advantages of the thermoregulating composite materials fabricated according to the instant methods to a commercially useful scale, wherein, according to many embodiments, the thermoregulating composite materials exhibit unprecedented range of heat-management properties in a single material, such that their ability to block IR radiation can be modulated by simple mechanical means in real time on a scale ranging from the IR-reflecting potency of the conventional “space blanket” technology/material to zero or near zero IR-reflectivity. In many embodiments, the advantageous heat management properties of the instantly described thermoregulating composite materials make them especially suitable for applications requiring highly effective user-tunable insulation, such as, for example, various food and beverage packaging applications, thermoregulating clothing, medical warming devices, and soft robotics.

### Computational Model for Heat Transfer Control by the Thermoregulating Composite Materials

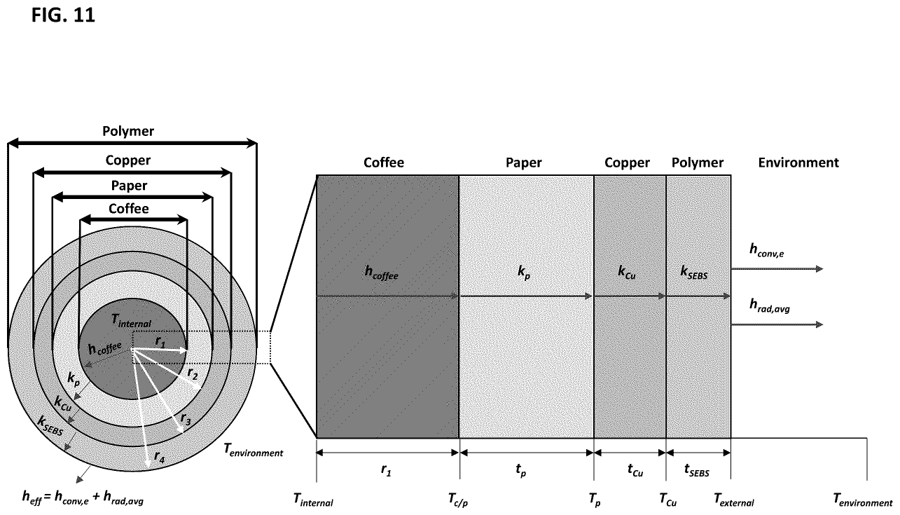

In many embodiments, the heat-management properties of the thermoregulating composite materials and parts fabricated according to the instantly described methods are dynamic and can be regulated/adjusted with good control with help of, in some embodiments, the computationally derived model described herein, or another suitable model according to other embodiments. More specifically, in many embodiments, the computational model derived as described in FIG. 11 allows to predict and, thus, manage, the IR-reflecting (i.e., heat managing) properties of the thermoregulating composite materials in scenarios involving a hot liquid-filled paper cup. In some embodiments, the computational model derivation approach described herein is modified and adjusted as needed (and as would be understood by any artisan in practicing in the art) to suit any other heat management application and or scenario utilizing the instant composite materials, including different sizes and shapes of objects or matter in need of thermal regulation, and or different temperature ranges and or environments, including both heating and cooling scenarios and applications. In this particular example, the computational model is developed for predicting the heat transfer rate between the cup system described in FIG. 11, comprising a hot liquid (here, “coffee”) filled paper cup wrapped in a cozy comprising the thermoregulating composite material at a given amount of strain, and the cup system's external environment (here, room temperature conditions). Notably, the instant computational model treats the thermoregulating composite material at various strains as different cup systems, as explained below. In addition, the instant computational model appears to work well for various materials, wherein it can be also applied to cup systems comprising, for example, a different cup material, or a different wrapper/cozy material, wherein the wrapper material may, for example, comprise a metalized polymer (e.g., Mylar™), or a non-metalized polymer (e.g., SEBS), such that, the computational model of some embodiments can be used to predictively compare heat regulating performances of the thermoregulating composite materials to those of, for example, other conventional packaging materials. Furthermore, the instantly disclosed computational model accounts for the conductive, convective, and radiative heat transfer mechanisms anticipated in realistic situations, and also makes some reasonable assumptions (listed below) to facilitate and simplify the overall analysis. To this end, according to many embodiments, some of the assumptions relied upon in the instant computational model development include:
1) the cup is completely filled with coffee/liquid, and the geometry of the cup is approximately cylindrical;
2) the thermal and physical properties of the hot liquid/coffee resemble those of water;
3) there is no mass transport from the cup system to the surroundings, i.e., the liquid content of the cup is not lost through evaporation;
4) the surface of the thermoregulating composite material comprising the IR-reflecting layer, or, where relevant, the metallized surface of any other metallized polymer, is immediately adjacent to (i.e., in direct contact with) the exterior surface of the paper cup;
5) the thermoregulating composite material is represented as the elastomeric matrix coated with a planar metal (here, copper) layer, i.e., the metal nanostructures embedded into the elastomeric matrix of the thermoregulating composite material are omitted for simplicity;
6) the convective heat transfer coefficient and other physical parameters of the hot liquid/coffee (effectively water), the convective heat transfer coefficient of air, the thermal conductivity of the polymer of the elastomeric matrix (here, SEBS), the thermal conductivity of the cup's paper, and the thermal conductivity of copper can be approximated by reported and well-known literature values (for example, in: Powell, R. W.; et al. Thermal Conductivity of Selected Materials. (Washington, DC: US Department of Commerce, National Bureau of Standards, 1966); Kosky, P.; et al. Exploring Engineering: An Introduction to Engineering and Design 3rd edn (Academic Press, 2013); Lavrykov, S. A.; Ramarao, B. V. Thermal properties of copy paper sheets. Dry. Technol. 30, 297-311 (2012); Tsutsumi, N. in Structure and Properties of Multiphase Polymeric Materials (eds Araki, T., Shibayama, M. & Tran-Cong, Q.) 393-422 (Marcel-Dekker, Inc., 1998); and Meseguer, J.; et al. Spacecraft Thermal Control (Woodhead Publishing, 2012), the disclosures of which are incorporated herein by reference) also provided in Table 1 below;
7) the average emittance (ε) values for all of: the uncovered (bare) cup, the polymer (here, SEBS) film covered cup, the Mylar™ covered cup, and the thermoregulating composite material covered cup—can be approximated from the corresponding transmittance (τ) and reflectance (ρ) values, that can be obtained experimentally, according to the formula:

$$ε = 1 - τ - ρ ,$$

as reported in Table 2 below;
8) the emittance of the environment is unity (one), i.e., the environment behaves as a black body.
   Based on these assumptions, the coffee-filled cups are approximated by the configuration schematically illustrated in FIG. 11, while the estimated, measured, and calculated parameters associated with this configuration are presented in Tables 1 and 2. The configuration and parameters used for the calculations are also described below.

TABLE 1
Various Physical Parameters For The Computational Model's Cup System Components.

| Parameter Name | Symbol | Value | Units |
|---|---|---|---|
| Convective heat transfer coefficient of coffee (water)^{S13} | h_{coffee} | 290 | $[ \frac{W}{{m}^{2} K} ]$ |
| Convective heat transfer coefficient of air^{S14} | h_{conv,e} | 11 | $[ \frac{W}{{m}^{2} K} ]$ |
| Average radiative heat transfer coefficient | h_{rad,avg} | Composite (0% Strain) + Paper & | $[ \frac{W}{{m}^{2} K} ]$ |
| | | 2.5 | |
| | | Composite (10% | |
| | | Strain) + Paper = | |
| | | 2.7 | |
| | | Composite (20% | |
| | | Suain) + Paper = | |
| | | 3.0 | |
| | | Composite (30% | |
| | | Strain) + Paper # | |
| | | 3.3 | |
| | | SEBS Polymer + | |
| | | Paper = 5.7 | |
| | | Metallized Mylar | |
| | | Sheet + Paper = 3.0 | |
| | | Paper = 5.8 | |
| Thermal conductivity of paper^{S15} | kₚ | 0.06 | $[ \frac{W}{mK} ]$ |
| Thermal conductivity of copper^{S13} | k_{Cu} | 385 | $[ \frac{W}{mK} ]$ |
| Thermal conductivity of the SEBS polymer^{S16} | k_{SEBS} | 0.19 | $[ \frac{W}{mK} ]$ |
| Thermal conductivity of the metallized Mylar sheets^{S17} | k_{MS} | 0.15 | $[ \frac{W}{mK} ]$ |
| Boltzmann constant | σ | 5.67 × 10⁻⁸ | $[ \frac{W}{{m}^{2} {K}^{4}} ]$ |
| Paper | tₚ | 0.7 | [mm] |
| thickness | | | |
| Copper | t_{Cu} | 0.00011 | [mm] |
| thickness | | | |
| SEBS Polymer | t_{SEBS} | 0.02989 | [mm] |
| thickness | | | |
| Metallized Mylar sheet | t_{MB} | 0.0105 | [mm] |
| thickness | | | |
| Inner radius | r₁ | 34.95 | [mm] |
| of the cup | | | |
| Height | L | 87.47 | [mm] |
| of the cup | | | |
| Volume | V_{coffee} | 0.000335 | [m³] |
| of coffee | | | |
| Specific heat capacity of coffee (water)^{S18} | c_{w} | 4184 | $[ \frac{J}{kgK} ]$ |
| Initial temperature | Tᵢₙₜₑᵣₙₐₗ | 358 | [K] |
| of the coffee | (t = 0) | | |
| Temperature | Tₑₙᵥᵢᵣₒₙₘₑₙₜ | 293 | [K] |
| of the environment | | | |

TABLE 2
Reflectance, Transmittance, And Emittance Values For
The Computational Model's Cup System Components.

| Material Type | Reflectance, ρ | Transmittance, τ | Emittance, ε |
|---|---|---|---|
| Bare | 0.14 | 0.01 | 0.85 |
| Paper Cup | | | |
| SEBS Polymer Film | 0.16 | 0.01 | 0.83 |
| on a Paper Cup | | | |
| Metallized Mylar | 0.55 | 0.01 | 0.44 |
| Sheet on a Paper Cup | | | |
| Composite at 0% | 0.63 | 0.01 | 0.36 |
| Strain on a Paper Cup | | | |
| Composite at 10% | 0.59 | 0.01 | 0.40 |
| Strain on a Paper Cup | | | |
| Composite at 20% | 0.55 | 0.01 | 0.44 |
| Strain on a Paper Cup | | | |
| Composite at 30% | 0.51 | 0.01 | 0.48 |
| Strain on a Paper Cup | | | |

First, the emittance of a cup system & is calculated according to Kirchhoff's Law of Thermal Radiation by using the following equation:

$$ε = α = 1 - τ - ρ , \qquad ( 1 )$$

wherein α is the absorptance, τ is the transmittance, and ρ is the reflectance. Here, & is calculated from experimentally measured τ and ρ for each given cup system, wherein a cup system comprises at least a paper cup, and the cup may be further wrapped in a thermoregulating material, which, in turn, may be strained to some degree, such that any such combination is a unique cup system with unique ε. Next, the radiative heat transfer coefficient h_{rad} is calculated according to Newton's Law of Cooling and the Stefan-Boltzmann Law by using the following equation:

$${h}_{rad} = εσ ( {T}_{external}^{2} + {T}_{environment}^{2} ) ( {T}_{external} + {T}_{environment} ) , \qquad ( 2 )$$

where Tₑₓₜₑᵣₙₐₗ is the temperature of the outer surface of the cup system wrapped in the thermoregulating composite material, Tₑₙᵥᵢᵣₒₙₘₑₙₜ is the temperature of the environment, o is the Stefan-Boltzmann constant, and ¿ is the emittance of the outer surface of the cup system. The average radiative heat transfer coefficient h_{rad,avg} is calculated according to the following equation:

$${h}_{rad , avg} = \frac{{h}_{rad} ( {T}_{external} = {T}_{internal} ( t = 0 ) ) + {h}_{rad} ( {T}_{external} = {T}_{environment} )}{2} , \qquad ( 3 )$$

where Tᵢₙₜₑᵣₙₐₗ (t=0) is the initial coffee/liquid temperature and t is time. Next, the overall effective heat transfer coefficient h_{eff} for a cup system is calculated according to the following equation:

$${h}_{eff} = {h}_{conv , e} + {h}_{rad , avg} , \qquad ( 4 )$$

where h_{conv,e} is the convective heat transfer coefficient of air. Furthermore, the temperature of the coffee inside the cup system Tᵢₙₜₑᵣₙₐₗ(t) is calculated according to Fourier's Law for cylindrical objects by using following equation:

$${T}_{internal} ( t ) = \frac{q ( t )}{2 π {r}_{1} {Lh}_{coffee}} + {T}_{c / p} ( t ) , \qquad ( 5 )$$

where q(t) is the total heat flow rate, r is the inner radius of the paper cup, L is the height of the paper cup, h_{coffee} is the convective heat transfer coefficient of the “coffee” (i.e., here, water for simplicity of the calculations), and T_{c/p}(t) is the temperature of the coffee in contact with the inner wall of the paper cup. In turn, the temperature of the coffee in contact with the inner wall of the paper cup T_{c/p}(t) is calculated according to Fourier's Law for cylindrical objects by using the following equation:

$${T}_{c / p} ( t ) = \frac{q ( t ) ln \frac{{r}_{2}}{{r}_{1}}}{2 π {Lk}_{p}} + {T}_{p} ( t ) , \qquad ( 6 )$$

where r₂ is the outer radius of the paper cup, kₚ is the thermal conductivity of paper, and Tₚ(t) is the temperature of the outer wall of the paper cup in contact with the metal of the metal layer of the cup's wrapper (i.e., here, copper). In turn, the temperature of the outer wall of the paper cup in contact with the metal Tₚ(t) is calculated according to Fourier's Law for cylindrical objects by using the following equation:

$${T}_{p} ( t ) = \frac{q ( t ) ln \frac{{r}_{3}}{{r}_{2}}}{2 π {Lk}_{Cu}} + {T}_{Cu} ( t ) , \qquad ( 7 )$$

where r₂ is the outer radius of the paper cup, r₃ is the combined outer radius of the cup and metal layer of the wrapper (i.e., here copper layer), k_{Cu} is the thermal conductivity of the metal/copper layer, and T_{Cu}(t) is the temperature of the metal/copper layer in contact with the polymer layer of the cup's wrapper/the elastomeric matrix of the composite materials (i.e., here, SEBS). In turn, the temperature of the metal layer in contact with the polymer layer T_{Cu}(t) is calculated according to Fourier's Law for cylindrical objects by using the following equation:

$${T}_{Cu} ( t ) = \frac{q ( t ) ln \frac{{r}_{4}}{{r}_{3}}}{2 π {Lk}_{SEBS}} + {T}_{external} ( t ) , \qquad ( 8 )$$

where r₄ is the combined outer radius of the cup, the metal (copper) layer, and the polymer (SEBS) layer, K_{SEBS} is the thermal conductivity of the SEBS polymer, and Tₑₓₜₑᵣₙₐₗ(t) is the temperature of the external surface of the polymer layer exposed to the surrounding environment. Furthermore, the temperature of the external surface of the wrapper's polymer layer exposed to the surrounding environment Tₑₓₜₑᵣₙₐₗ(t) is calculated according to Fourier's Law for cylindrical objects by using the following equation:

$${T}_{external} ( t ) = \frac{q ( t )}{2 π {r}_{4} {Lh}_{eff}} + {T}_{environment} , \qquad ( 9 )$$

where h_{eff} is the effective heat transfer coefficient. Next, the temperature of the coffee inside the cup system Tᵢₙₜₑᵣₙₐₗ(t) is updated by substituting equations (6)-(9) into equation (5) and calculated by using the following equation:

$${T}_{internal} ( t ) = \frac{q ( t )}{2 π L} ( \frac{1}{{h}_{coffee} {r}_{1}} + \frac{ln \frac{{r}_{2}}{{r}_{1}}}{{k}_{p}} + \frac{ln \frac{{r}_{3}}{{r}_{2}}}{{k}_{Cu}} + \frac{ln \frac{{r}_{4}}{{r}_{3}}}{{k}_{SEBS}} + \frac{1}{{h}_{eff} {r}_{4}} ) + {T}_{environment} . \qquad ( 10 )$$

In turn, the overall heat transfer coefficient for the coffee in the cup system U is defined from equation (10) and calculated by using the following equation:

$$U = \frac{1}{{h}_{coffee} {r}_{1}} + \frac{ln \frac{{r}_{2}}{{r}_{1}}}{{k}_{p}} + \frac{ln \frac{{r}_{3}}{{r}_{2}}}{{k}_{Cu}} + \frac{ln \frac{{r}_{4}}{{r}_{3}}}{{k}_{SEBS}} + \frac{1}{{h}_{eff} {r}_{4}} . \qquad ( 11 )$$

Moreover, the temperature of the coffee inside the cup system Tᵢₙₜₑᵣₙₐₗ(t) is updated by substituting equation (11) into equation (10), and calculated by using the following equation:

$${T}_{internal} ( t ) = \frac{q ( t )}{2 π L} U + {T}_{environment} . \qquad ( 12 )$$

The energy balance for the overall system, i.e., the coffee-filled cup system and the surrounding environment, is defined according to the following equation:

$$\frac{d}{dt} ( {T}_{internal} ( t ) ) = - \frac{1}{{mc}_{w}} q ( t ) , \qquad ( 13 )$$

where m is the mass of the coffee and c_{w} is the heat capacity of the “coffee” (here, water). The energy balance for the overall cup system is next updated by substituting equation (12) into equation (13), and calculated by using the following equation:

$$\frac{d}{dt} ( {T}_{internal} ( t ) ) = - \frac{1}{{mc}_{w}} \frac{( {T}_{internal} ( t ) - {T}_{environment} ) 2 π L}{U} . \qquad ( 14 )$$

Furthermore, the temperature of the coffee inside the cup system Tᵢₙₜₑᵣₙₐₗ(t) is defined by solving equation (14) under the initial condition of Tᵢₙₜₑᵣₙₐₗ(t=0)=85° C.=358K and calculated by using the following equation:

$${T}_{internal} ( t ) = ( {T}_{internal} ( t = 0 ) - {T}_{environment} ) {e}^{- \frac{1}{{mc}_{w}} \frac{2 π L}{U} t} ) + {T}_{environment} . \qquad ( 15 )$$

Finally, the cooling rate constant k, is calculated by using the following equation:

$$k = \frac{d ( ln ( {T}_{internal} ( t ) - {T}_{environment} ) )}{dt} . \qquad ( 16 )$$

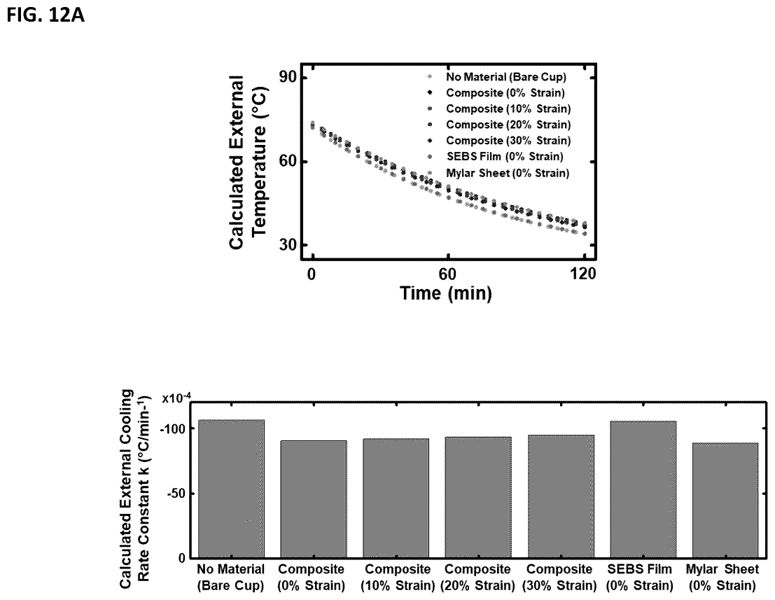

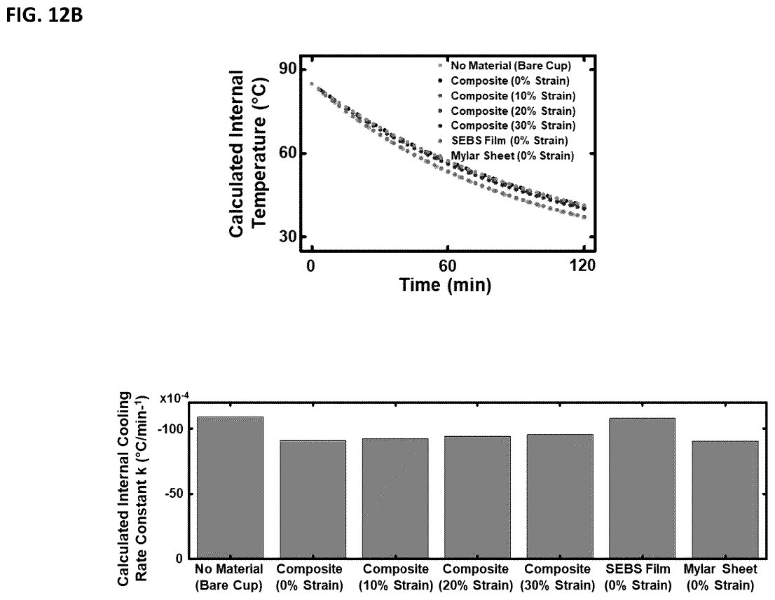

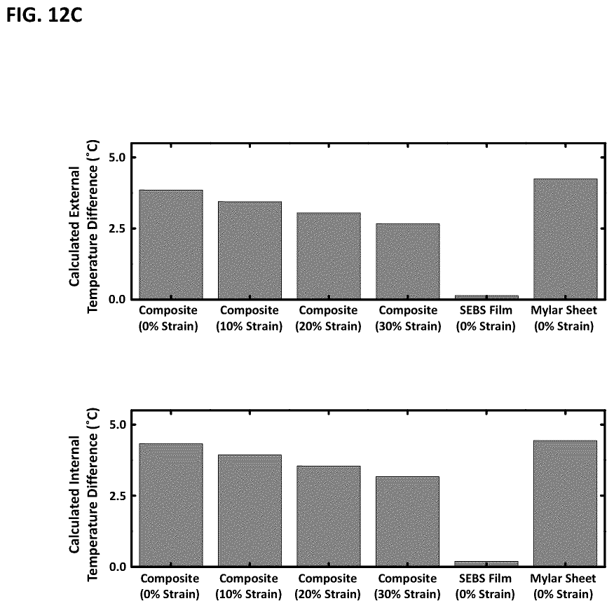

FIGS. 12A through 12C provide data calculated according to the instant computational model for various cup systems. More specifically, the graphs on the top of FIGS. 12A and 12B show the computational model predictions for how the external and, respectively, internal temperatures of a given cup system are expected to change as a function of time. Furthermore, the bar plots on the bottom of FIGS. 12A and 12B show the computational model predictions for the expected external and internal cooling rates for the same cup systems. In addition, for each cup system presented in FIGS. 12A and 12B, FIG. 12C provides the computational model-based predictions for the calculated difference in temperatures (external and internal to the cup system, top and bottom of FIG. 12C, respectively) between a given cup system and a comparable bare cup at 90 minutes of the experiment. Notably, all of the data afforded by the instantly disclosed computational model of many embodiments closely resembles the experimentally obtained data, as can be seen by comparing the experimental data presented in FIGS. 10E through 10H and the corresponding theoretically predicted data in FIGS. 12A and 12B, as well as by comparing the experimental data in FIGS. 10C and 10D and the corresponding theoretically predicted data in FIG. 12C. Accordingly, in many embodiments, the instant computational model provides nuanced insight into the interfacial temperature distributions for thermoregulating systems comprising the thermoregulating composite material, that are difficult to obtain experimentally, and allows for prediction and optimization of the heat managing performance of the thermoregulating composite materials of the instant application.

### Computational Model/Simulation for Predicting IR-Reflecting and Transmitting Properties of the Composite Materials for Precise Thermoregulating Control

In many embodiments, the dynamic heat-management (i.e., infrared) properties of the thermoregulating composite materials and parts fabricated according to the instantly described methods may be computationally modeled/simulated with help of computational software, such as, for example, described herein, thus affording tools for regulating/adjusting such properties with good control in actual applications. For example, in many embodiments, a suitable computational model accounts for varying the thickness of the planar component of the IR-reflecting layer of the instant composite materials (at production stage) as one of the parameters responsible for the thermoregulating properties of the composite materials, and, as such, allows to use the said parameter to predict and, thus, manage, various heat management scenarios using the composite materials. Of course, in some embodiments, the computational model approach is selected, modified, and adjusted as needed (and would be understood by any artisan practicing in the art) to suit any heat management application and or scenario utilizing the instant composite materials, including different sizes and shapes of objects or matter in need of thermal regulation, and or different temperature ranges and or environments, including both heating and cooling scenarios and applications.

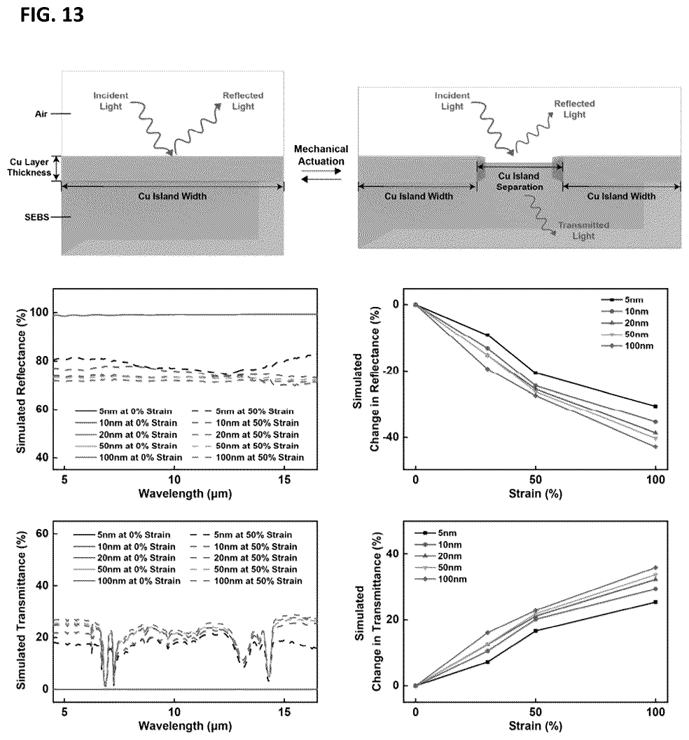

As one particular example of suitable modeling/simulation methods, the reflectance and transmittance values for the composite materials comprising Cu as the IR-reflecting material and SEBS as the elastomeric matrix material, and having different thicknesses of the planar component of the IR-reflecting layer (i.e., 5 nm, 10 nm, 20 nm, 50 nm, 100 nm) were calculated with help of specialized software for the before and after application of strain (i.e., actuation) scenarios schematically illustrated in FIG. 13 (top), wherein infrared light is reflected and transmitted in air by a two-dimensional unit cell consisting of uniformly-distributed and periodic surface IR-reflecting domains of the composite material. In the present example, the Electromagnetic Waves, Frequency Domain Interface of the Wave Optics Module in COMSOL Multiphysics 5.6™ (COMSOL™) software was used as described herein and in Multiphysics, C. Wave Optics Module User's Guide 5.6 (COMSOL Inc, 2020), the disclosure of which is incorporated herein by reference. As such, the simulation and calculations required the following input parameters: 1) the thickness of the IR-reflecting domains (i.e., the thickness of the planar component) H_{Cu}, 2) the average separation between the IR-reflecting domains Wₛₑₚ, 3) the complex refractive index of air n̅ₐᵢᵣ, 4) the complex refractive index of Cu n̅_{Cu}, and 5) the complex refractive index of SEBS n̅_{SEBS}. To this end, first, the thickness of the IR-reflecting domains H_{Cu} was estimated by using the following equation:

$${H}_{Cu} = {H}_{planar} + {H}_{nano} , \qquad ( 1 )$$

wherein Hₚₗₐₙₐᵣ is the thicknesses of the Cu layer overlaying SEBS/elastomeric matrix (i.e., the planar component of the IR-reflecting layer) extracted from the corresponding SEM images, and Hₙₐₙₒ is the height of the SEBS-embedded Cu nanostructures (i.e., the nanostructured component of the IR-reflecting layer) also extracted from the relevant SEM images. Next, the average separation between the IR-reflecting domains, Wₛₑₚ, was estimated by using the following equation:

$${W}_{sep} = {W}_{Cu} \times \frac{1 - ρ}{ρ} , \qquad ( 2 )$$

wherein W_{Cu} is the average width of an IR-reflecting domain extracted from the relevant SEM images, and ρ is the fractional surface coverage by the IR-reflecting domains extracted from the relevant SEM images. In addition, the complex refractive index of air, n̅ₐᵢᵣ, was estimated by using the following equation:

$${\overline{n}}_{air} = {n}_{air} + {ik}_{air} , \qquad ( 3 )$$

wherein nₐᵢᵣ is the real part of the complex refractive index reported in the literature and kₐᵢᵣ is the imaginary part of the complex refractive index reported in the literature (see, for example, Ciddor, P. E. Refractive index of air: new equations for the visible and near infrared. Appl. Opt. 35, 1566-1573 (1996), the disclosure of which is incorporated herein by reference). Furthermore, the complex refractive index of Cu, n̅_{Cu}, was estimated by using the following equation:

$${\overline{n}}_{Cu} = {n}_{Cu} + {ik}_{Cu} , \qquad ( 4 )$$

wherein n_{Cu} is the real part of the complex refractive index reported in the literature and k_{Cu} is the imaginary part of the complex refractive index reported in the literature (see, for example, Ordal, M. A., et al. Optical properties of fourteen metals in the infrared and far infrared: Al, Co, Cu, Au, Fe, Pb, Mo, Ni, Pd, Pt, Ag, Ti, V, and W. Appl. Opt. 24, 4493-4499 (1985), the disclosure of which is incorporated herein by reference). Next, the complex refractive index of SEBS, n̅_{SEBS}, was estimated by using the following equation:

$${\overline{n}}_{SEBS} = {n}_{SEBS} + {ik}_{SEBS} , \qquad ( 5 )$$

where n_{SEBS} is the real part of the complex refractive index calculated by using equation (8) below and k_{SEBS} is the imaginary part of the complex refractive index calculated by using equation (6) below (as explained in, for example, Nichelatti, E. Complex refractive index of a slab from reflectance and transmittance: Analytical solution. J. Opt. A Pure Appl. Opt. 4, 400-403 (2002), the disclosure of which is incorporated herein by reference).

To this end, the imaginary part k_{SEBS} of the complex refractive index n̅_{SEBS} was estimated by using the following equation:

$${k}_{S E B S} = \frac{λ}{4 π h} ln ( \frac{r {T}_{S E B S}}{{R}_{S E BS - r}} ) , \qquad ( 6 )$$

wherein A is the wavelength of the incident light, h is the thickness of the SEBS layer (i.e., the elastomeric matrix), R_{SEBS} is the measured total reflectance of SEBS, T_{SEBS} is the measured total transmittance of SEBS, and r is the reflectance at the air-SEBS interface calculated by using equation (9). Next, the reflectance at the air-SEBS interface r was estimated by using the following equation:

$$r = \frac{2 + {T}_{SEBS}^{2} - {( 1 - {R}_{S E B S} )}^{2} - \sqrt{\begin{matrix}{( 2 + {T}_{SEBS}^{2} - {( 1 - {R}_{S E B S} )}^{2} )}^{2} - \\ 4 {R}_{S E B S} ( 2 - {R}_{S E B S} )\end{matrix}}}{2 ( 2 - {R}_{S E B S} )} . \qquad ( 7 )$$

Finally, the real part n_{SEBS} of the complex refractive index of SEBS, n̅_{SEBS}, was estimated by using the following equation:

$${n}_{S E B S} = \frac{1 + r}{1 - r} + \sqrt{{( \frac{1 + r}{1 - r} )}^{2} - 1 - {k}_{S E B S}^{2}} . \qquad ( 8 )$$

Accordingly, FIG. 13 presents the outcome of the quantitative evaluation of the composite materials' infrared properties enabled by the computational model/simulation example described herein, including the simulated reflectance (FIG. 13, middle, left) and transmittance (FIG. 13, bottom, left) data for hypothetical samples of the composite material (comprising Cu as the IR-reflecting material, 90 nm tall (slanted) nanostructures as the nanostructured component, and the planar component of various thicknesses; as well as 35 μm-thick elastomeric matrix comprising SEBS as the polymer) at different hypothetical strains conducted over the wavelength range of 4.5-16.5 μm. In addition, the average reflectance/transmittance value changes were calculated for the same hypothetical samples of the composite material over the wavelength range of 4.5-16.5 μm by subtracting the average values at strains of 0% from the average values at strains of >0% (FIG. 13, middle and bottom, right).

More specifically, FIG. 13, middle row, shows the calculated total infrared reflectance spectra (left) and calculated changes in the average reflectance (right) obtained for the composite materials with varying thickness of the planar component of the IR-reflecting layer at different strains. As can be seen here, for the composite materials with 5 nm and 10 nm-thick planar components, the simulated spectra afforded average total reflectance values of ˜99% and ˜99%, respectively, at 0% strain, with the reflectance values decreasing to ˜79% and ˜75%, respectively, at 50% strain (FIG. 13, middle, left). In turn, for composite materials with thicker, 20 nm, 50 nm, and 100 nm-thick planar components, the simulated spectra yielded average total reflectance values of ˜99%, ˜99%, and ˜99%, respectively, at 0% strain, with the reflectance values decreasing to ˜74%, ˜73%, and ˜72%, respectively, at 50% strain (FIG. 13, middle, left). In general, the calculated changes in the total reflectance progressively increased with the applied strain and were maximized for the composite materials with the thickest planar components (FIG. 13, middle, right). Furthermore, for the composite materials with 5 nm and 10 nm-thick planar component of the IR-reflecting layer, the simulated spectra afforded average total transmittance values of ˜0% and ˜0%, respectively, at 0% strain, with the transmittance values increasing to ˜17% and ˜20%, respectively, at 50% strain (FIG. 13, bottom, left). In addition, for composite materials with thicker, 20 nm, 50 nm, and 100 nm-thick planar component, the simulated spectra produced average total transmittance values of ˜0%, ˜0%, and ˜0%, respectively, at 0% strain, with the transmittances increasing to ˜21%, ˜22%, and ˜23%, respectively, at 50% strain (FIG. 13, bottom, left). In general, the calculated changes in the total transmittance progressively increased with the applied strain and were maximized for the composite materials with the thickest planar components (FIG. 13, bottom, right). Accordingly, all of the simulated data provided in FIG. 13 is in close agreement with the actual experimental data provided in FIG. 6G, which provides a powerful validation of the instantly described computational model/simulation of many embodiments, and an encouragement to utilize this model as a reliable and dependable tool in predicting and controlling the thermoregulating properties of the composite materials of the instant disclosure according to many embodiments.

Accordingly, in many embodiments, the thermoregulating composite materials with tunable heat-management properties and parts comprising thereof are fabricated according to the methods disclosed herein to possess commercially relevant, large areas and any desired shape/form. Moreover, in many embodiments, the methods employed in the fabrication of the thermoregulating composite materials comprise easily scalable, commercially relevant steps and processes, such as: electron-beam evaporation, spray coating, and delamination from a flexible substrate, and require only conventional, readily available, and relatively inexpensive starting materials, such as, for example: copper, SEBS, and aluminum foil. Furthermore, in many embodiments, the methods for fabrication of the thermoregulating composite materials reported herein allow for facile production of heat managing parts of various forms, shapes, and sizes, such as highly flexible rectangles, arches and sheets, which, in turn, can be next wrapped around any desired 3D form. In many embodiments, the instant fabrication methods allow to obtain the shape-variable, thermoregulating composite materials in previously unattainable sizes, among the largest of any system prepared by glancing angle deposition (Hawkeye, M. M., Taschuk, M. T. & Brett, M. J. Glancing Angle Deposition of Thin Films: Engineering the Nanoscale (Wiley, 2014), the disclosure of which is incorporated herein by reference). In many embodiments, the methods for fabrication of the thermoregulating composite materials compare favorably to those employed in fabrications of ubiquitous metallized films. In many embodiments, the thermoregulating composite materials are adjustable and demonstrate well-controlled heat managing capabilities, wherein the heat managing capabilities are predictably controllable according to, for example, the computational model and methods of some embodiments disclosed herein, or other computational models. In many embodiments, the computational model and methods described herein, afford means of heat management by describing the structure-function relationships of the morphologically reconfigurable thermoregulating composite materials/parts of the instant disclosure, and by quantifying the interplay between the specular and diffuse reflection and transmission of infrared light by such materials and parts. In many embodiments, the computational models and methods of heat management are adapted and optimized as needed for any particular application and composition of the thermoregulating composite material. In many embodiments, the adaptive mid-infrared functionalities of the thermoregulating composite materials and associated figures of merit comprise the total reflectance and transmittance switching ratios of ˜2 and ˜23, respectively. In many embodiments, the thermoregulating composite materials fabricated according to the instant methods and procedures withstand extreme deformation before irreversible failure, and maintain their tunable infrared functionalities even after 10,000 strain cycles. In many embodiments, the functional stabilities of the thermoregulating composite materials are on a par with, or better than, the best stabilities found for any other known adaptive infrared material In many embodiments, the thermoregulating composite materials possess many of the desirable thermal properties of other heat managing technologies, such as, for example, the space blanket technology (i.e., a metallized polymer film), but, in addition, they can efficiently modulate an ˜25-31 W m⁻² heat flux with a minimal energy input of ˜3 W m⁻², and dynamically control the exchange of heat between an object and its surroundings (given some temperature difference exists between the two). In many embodiments, the thermoregulating composite materials fabricated according to the methods of many embodiments are excellent candidates for clothing or packaging applications, especially food packaging applications, wherein the composite materials offer controllable regulation of the heat exchange between a package's content and that package's external surface to user's specifications.

In addition, in many embodiments, the thermoregulating composite materials and the methods of fabrication thereof described herein are safe and sustainable, as they rely on established and conventional possesses and starting materials known to be easily recyclable. For example, for the thermoregulating composite materials comprising, in some embodiments, copper, it should be noted that copper-based alloys have been used since antiquity in water containers, copper is an essential dietary trace element with a relatively high recommended consumption limit, and solid copper possesses well-known antimicrobial properties that could be advantageous in, for example, packaging applications (as discussed, for example, in: National Research Council. Copper in Drinking Water (National Academies Press, 2000); El-Kady, A. A.; Abdel-Wahhab, M. A. Occurrence of trace metals in foodstuffs and their health impact. Trends Food Sci. Technol. 75, 36-45 (2018); Ramos, M.; et al. New trends in beverage packaging systems: a review. Beverages 1, 248-272 (2015); Prohaska, J. R. Impact of copper deficiency in humans. Ann. N.Y. Acad. Sci. 1314, 1-5 (2014); Antimicrobial Copper Alloys—Group I and Associated Fabricated Products Master Label (US EPA, 2021); https://www3.epa.gov/pesticides/chem_search/ppls/082012-00001-20210110.pdf; and Salah, I.; et al. Copper as an antimicrobial agent: recent advances. RSC Adv. 11, 18179-18186 (2021), the disclosures of which are incorporated herein by reference). In some embodiments, the thermoregulating composite materials and parts comprising thereof are designed with facile and or conventional recycling in mind. For example, the composite materials comprising copper as the IR-reflecting layer can first have their copper layer completely dissolved away with common vinegar (as, for example, described in: Choi, Y. S.; et al. Extraction of chromium, copper, and arsenic from CCA-treated wood by using wood vinegar. Bioresour. Technol. 120, 328-331 (2012); and Liu, F.; et al. Migration of copper from nanocopper/LDPE composite films. Food Addit. Contam. A 33, 1741-1749 (2016), the disclosures of which are incorporated herein by reference), after which the remaining elastomeric matrix (e.g., SEBS polymer) can be further conventionally recycled in bulk quantities (as, for example, described in: Alberghini, M. et al. Sustainable polyethylene fabrics with engineered moisture transport for passive cooling. Nat. Sustain. 4, 715-724 (2021); Drobny, J. G. Handbook of Thermoplastic Elastomers 2nd edn; and Shen, Z.; Feng, J. Mass-produced SEBS/graphite nanoplatelet composites with a segregated structure for highly stretchable and recyclable strain sensors. J. Mater. Chem. C 7, 9423-9429 (2019), the disclosures of which are incorporated herein by reference).

In many embodiments, the fabrication of the thermoregulating composite materials and parts comprising thereof according to the methods disclosed herein is very low cost. For example, the manufacturing costs for the thermoregulating composite materials can be calculated based on extensive precedent established for the manufacturing of laminates, composites, coated sheets, and metallized films in the packaging (and other) industries (such as disclosed in, for example: Bader, M. G. Selection of composite materials and manufacturing routes for cost-effective performance. Compos. Part A Appl. Sci. Manuf. 33, 913-934 (2002); Esawi, A. M. K.; Ashby, M. F. Cost estimates to guide pre-selection of processes. Mater. Des. 24, 605-616 (2003); Centea, T.; Nutt, S. R. Manufacturing cost relationships for vacuum bag-only prepreg processing. J. Compos. Mater. 50, 2305-2321 (2016); IHS Markit. Specialty Plastic Films—Process Economics Program Report 159B (economic values updated in 2021) (1993); https://ihsmarkit.com/products/chemical-technology-pepspecialty-plastic-films-1993.html; and Decker, W.; et al. Metallized polymer films as replacement for Aluminum foil in packaging applications. Proc. Annu. Tech. Conf. Vac. Coaters 47, 594-599 (2004), the disclosures of which are incorporated herein by reference) as described below. To this end, the total cost of the manufacturing for metallized polymer sheets C_{Total,PS} can be estimated by using the following equation, wherein tooling costs are omitted for straightforward geometries:

$${C}_{Total , PS} = {C}_{L , PS} + {C}_{MT , PS} + {C}_{M F , P S} , \qquad ( 1 C )$$

where C_{L,PS} represents the labor costs associated with manufacturing the metallized polymer sheets, C_{MT,PS} represents the total material costs for this manufacturing process, and C_{MF,PS} represents general manufacturing expenses. The labor costs C_{L,PS} incorporate all activities required for personnel to produce metallized polymer sheets and can be generally estimated by using the following equation:

$${C}_{L , PS} = {W}_{h o u r l y} + {\sum }_{i} {t}_{activity , i} , \qquad ( 2 C )$$

where W_{hourly} represents the hourly wage and t_{activity,i} represents the time associated with any specific manufacturing activity i. The material costs C_{MT,PS} incorporate all direct and indirect costs associated with producing metallized polymer sheets, and can be estimated by using the following equation:

$${C}_{MT , PS} = {C}_{M , metal} + {C}_{M , p o l y m e r} , \qquad ( 3 C )$$

where C_{M,metal} represents the required amount of metal (both deposited and wasted), and C_{M,polymer} represents the required amount of polymer (both processed and wasted). The manufacturing expenses C_{MF,PS} incorporate the general infrastructural expenses associated with producing metallized polymer sheets and can be estimated by using the following equation:

$${C}_{MT , PS} = {C}_{e q u i p ment} + {\sum }_{i} {C}_{other overhead , i} , \qquad ( 4 C )$$

where C_{equipment} represents the equipment (capital asset) acquisition and maintenance costs, and C_{other overhead,i} represents common location-specific overhead costs associated with manufacturing requirements i (e.g., warehousing, water, electricity, taxes, and other analogous ones). The costs described above for the manufacturing of metallized polymer sheets are well known to vary for different metal and polymer combinations, as well as across geographic locations due to logistical and infrastructural constraints, thus, making it most appropriate to represent the relative contribution of each cost component with a general range. For example, the labor costs C_{L,PS} typically constitute 3% to 12% of the total amount, the material costs C_{MT,PS} typically constitute 60% to 73% of the total amount, and the manufacturing expenses C_{MF,PS} typically constitute 24% to 28% of the total amount (as provided in Table 3 below). Consequently, for metallized polymer sheets, the labor costs C_{L,PS} span a range of ˜$0.002 to ˜$0.018 per square meter, the material costs C_{MT,PS} span a range of ˜$0.04 to ˜$0.09 per square meter (due to economies of scale), and the manufacturing expenses C_{MF,PS} span a range of ˜$0.013 to ˜$0.042 per square meter (Table 3). The total cost for the manufacturing of metallized polymer sheets C_{Total,PS} is therefore estimated as ˜$0.055 to ˜$0.15 per square meter from equation (1C) (Table 3). Accordingly, the total cost of manufacturing for the thermoregulating composite materials C_{Total,Composite} can be estimated by using a modified version of equation (1C):

$${C}_{Total , Composite} = {C}_{L , Comp osite} + {C}_{M T , C o m p osite} + {C}_{MF , Comp osite} , \qquad ( 5 C )$$

where C_{L,Composite} represents the labor costs associated with the manufacturing, C_{MT,Composite} represents the total material costs for the manufacturing process, and C_{MF,Composite} represents general manufacturing expenses. The total cost of manufacturing for our composite materials C_{Total,Composite} can be calculated by making reasonable assumptions based on the fact that our manufacturing approach requires standard industrial equipment and routine fabrication processes, e.g., electron beam evaporation, spray coating, and delamination. Therefore, the labor costs, e.g., training, associated with the manufacturing of our composites are assumed to be roughly equivalent to those established for the manufacturing of metallized polymer sheets, i.e., C_{L,Composite}≈C_{L,PS}, and moreover, the general expenses associated with the manufacturing of our composites are assumed to be roughly equivalent to those established for the manufacturing of metallized polymer sheets, i.e., C_{MF,Composite}≈C_{MF,PS}. Consequently, C_{Total,Composite} can be estimated by updating equation (5C):

$$F {C}_{Total , Composite} = {C}_{L , PS} + {C}_{M T , P S} + {C}_{MF , Comp osite} . \qquad ( 6 C )$$

The material costs C_{MT,Composite} associated with producing our composite materials can be estimated by using by using a modified version of equation (3C):

$${C}_{MT , Composite} = {C}_{M , metal} + {C}_{M , p o l y m e r} + {C}_{M , s o l vent} , \qquad ( 7 C )$$

where C_{M,metal} represents the required amount of copper (both deposited and wasted), C_{M,polymer} represents the required amount of SEBS (both processed and wasted), and CM, solvent represents the overall required amount of toluene. For our composite materials, the percent contributions of labor costs C_{L,Composite}, material costs C_{MT,Composite}, and manufacturing expenses C_{MF,Composite} to the total costs C_{Total,Composite} are estimated as comparable to those established for metallized polymer sheets. Thus, the labor costs C_{L,Composite} span a range of ˜$0.002 to ˜$0.018 per square meter, the material costs C_{MT,Composite} obtained from vendor quotes (without accounting for economies of scale) span a range of ˜$0.1 to ˜$0.13 per square meter, and the reported manufacturing expenses C_{MF,Composite} span a range of ˜$0.013 to ˜$0.042 per square meter (Table 3). The total cost for the manufacturing of our composite materials C_{Total,Composite} is therefore very conservatively estimated as ˜$0.115-˜$0.19 per square meter from equation (6C) (Table 3).

TABLE 3
Various Costs Associated With Fabrication Of Metallized Polymer Films And Estimates
Of Such Costs For Fabrication Of The Thermoregulating Composite Materials.

| Metallized | Historical | Historical Costs | Composite | Estimated Cost |
|---|---|---|---|---|
| Sheet Cost | Percentage of | for Metallized | Material Cost | for the Composite |
| Parameter | the Total Cost | Sheets (per m²) | Parameter | Materials (per m²) |
| C_{L, PS} | 3% to 12% %^{S11} | ~$ 0.002 to ~$ 0.018^{S11} | C_{L, Composite} | ~$ 0.002 to ~$ 0.018 |
| C_{MT, PS} | 60% to 73%^{S11} | ~$ 0.04 to ~$ 0.09^{S11, S12} | C_{MT, Composite} | ~$ 0.1 to ~$ 0.13 |
| C_{MF, PS} | 24% to 28%^{S11} | ~$ 0.013 to ~$ 0.042^{S11} | C_{MF, Composite} | ~$ 0.013 to ~$ 0.042 |
| C_{Total, PS} | ~100% | ~$ 0.055-~$ 0.15 | C_{Total, Composite} | ~$ 0.115-~$ 0.19 |

### EXEMPLARY EMBODIMENTS

The following examples are put forth so as to provide those of ordinary skill in the art with a complete disclosure and description of how to make and use the present invention, and are not intended to limit the scope of what the inventors regard as their invention, nor are they intended to represent that the experiments below are all or the only experiments performed. Efforts have been made to ensure accuracy with respect to numbers used (e.g., amounts, temperature, etc.), but some experimental errors and deviations should be accounted for. Unless indicated otherwise, parts are parts by weight, molecular weight is weight average molecular weight, temperature is in degrees Celsius, and pressure is at or near atmospheric. Standard abbreviations may be used, e.g., s or sec, second(s); min, minute(s); h or hr, hour(s); and the like.

### Example 1—Fabrication of the Large-Area Thermoregulating Composite Materials

The thermoregulating composite material comprising copper as the IR-reflecting layer (planar and nanostructured components) and SEBS block polymer as the elastomeric matrix was prepared according to the methods of many embodiments to possess large area (i.e., ˜570 cm²) (FIGS. 2A through 2F). To this end, first, a flexible aluminum foil was chosen as the support substrate for the fabrication process, and attached to a custom-built stainless-steel stage (Angstrom Engineering). Second, copper (Cu) was chosen as the metal of the IR-reflecting layer, and a ˜20 nm-thick planar Cu layer covered with ˜90 nm upright Cu columns was prepared on the support substrate in a two-step process by electron-beam evaporation using an EvoVac Series thin-film deposition system (Angstrom Engineering). Third, SEBS block copolymer (G1645, Kraton™) was chosen as the polymer of the elastomeric matrix, and a 5% (w/w) solution of this polymer in toluene (Fisher Chemical) was spray-coated onto the nanostructured side of the Cu layer deposited on the aluminum foil substrate placed on a heated spray-coating stage using a ⅕ HP Professional airbrushing system (Vivohome) mounted on a System 30M three-dimensional printer (Hyrel 3D); and the toluene was next evaporated from the surface avoiding polymer curing. Finally, to obtain the free-standing thermoregulating composite material of many embodiments, the entire composite structure was manually delaminated (detached) from the aluminum support substrate as a single uniform sheet with a size of ˜11 in×˜8 in (˜570 cm²) with help of a plastic frame adhered to the polymer side/surface of the composite material. Next, the thermoregulating composite materials fabricated as described here were used as is, or had their shape or form adjusted, or were incorporated as parts into heat managing systems for digital camera imaging, SEM, tensile testing, infrared spectroscopy, stability testing, and thermal characterization experiments described herein.

### Example 2—Fabrication of the Arch-Shaped Covers Comprising the Thermoregulating Composite Material

Arch-shaped coffee cup covers/cozies were prepared according to procedures of many embodiments. To this end, first, to delineate the desired shape, an arch was drawn directly onto the metal coated (i.e., IR-reflecting layer) side of a large-area thermoregulating composite material swath fabricated according to the methods described herein. Second, hook and loop fasteners (Velcro™) were incorporated into the arch-shaped cozy via an adhesive-enabled attachment to opposing ends of the delineated arch. In turn, the desired arch with pre-installed fasteners was excised from the large area composite material with a scalpel to complete the cozy. In addition, similar cozies comprising other materials, i.e., SEBS polymer film and, separately, metallized polymer film (Mylar™), were prepared according to the analogous methods for performance comparison purposes. The arch-shaped cup covers produced according to the instant methods were next used for the thermal characterization experiments.

### Example 3—Fabrication of Extra-Large Area Sheets Comprising the Large Area Thermoregulating Composite Material

Quilt-like, extra-large area blankets/sheets comprising the large area thermoregulating composite material were fabricated according to procedures of many embodiments. To this end, first, the as-fabricated large area thermoregulating composite material still overlaying the flexible foil substrate (i.e., pre-delamination) was trimmed (together with the flexible foil substrate) to a size of ˜8 in×˜7.5 in with a scalpel to obtain rectangular sections. Second, nine such rectangular sections comprising the thermoregulating composite material were attached edge-to-edge in a 3×3 manner by application of adhesive tape to the flexile foil substrate side, leaving narrow gaps between the edges of the rectangular sections on the opposite side. Third, to join the flexible foil substrate-bound composite materials, a 50% (w/w) SEBS solution in toluene was syringe-cast into the narrow gaps between the adjacent rectangular sections, and allowed to dry. Finally, to obtain a free-standing, quilt-like sheet, the nine joined rectangular sections comprising the thermoregulating composite material were simultaneously manually detached (delaminated) from their corresponding flexible foil substrates to yield a single blanket with a total size of ˜24 in×˜22.5 in (˜3,480 cm²).

### Example 4—Characterization of the Thermoregulating Composite Materials

Digital camera imaging of the nanostructured metal layers and the thermoregulating composite materials. The visible appearances of the thermoregulating composite materials were characterized by digital camera imaging. The digital images were obtained using a PowerShot SX520 digital single-lens reflex camera (Canon). The images were analyzed using the Photoshop software package (Adobe, Inc.). The digital camera images were obtained routinely and enabled detailed inspection of the composite materials and layers within thereof.

SEM imaging of the nanostructured metal layers and the thermoregulating composite materials. The surface morphologies of the nanostructured metal layers and the thermoregulating composite materials were imaged by SEM. The images were obtained using a Magellan 400 XHR scanning electron microscope (FEI). The Cu layers (typical sizes of 2 mm×6 mm) were not modified prior to imaging. The thermoregulating composite materials (typical sizes of 2 mm×6 mm) were subjected to the desired strains of 0, 30 or 50%, fixed with epoxy resin (Ted Pella), and covered with an ˜3-nm iridium layer using an EMS 150T sputter coater (Electron Microscopy Sciences) prior to imaging. The images of the nanostructured metal layers and the thermoregulating composite materials were obtained at various magnifications with typical accelerating voltages of 10 and 5 kV, respectively. The SEM images were obtained routinely and enabled evaluation of the thicknesses and morphologies of the nanostructured metal layers and the thermoregulating composite materials.

Tensile testing of the composite materials. The mechanical properties of the thermoregulating composite materials were characterized by standard methods. The measurements were performed using a 3365 Universal Testing System (Instron). The thermoregulating composite materials were mounted in the grips of the instrument, subsequently subjected to three cycles of 0-100% uniaxial strain at an elongation rate of 15 mm s⁻¹ and then stretched from 0% strain to their breaking strain at a rate of 30 mm s⁻¹. The Young's moduli were calculated from the linear regions of the engineering stress versus strain curves at a strain value of 30%. The tensile testing experiments were repeated on at least three different composite materials.

Infrared spectroscopy of the thermoregulating composite materials. The infrared functionalities of the composite materials were characterized by standard methods. The infrared spectra were obtained using a Frontier Fourier transform infrared (FTIR) spectrometer (PerkinElmer) fitted with a mid-infrared integrating sphere (Pike Technologies). The measurements were referenced to a diffuse gold standard (Pike Technologies). The free-standing and paper coffee cup-attached composite materials were mounted on home-built size-adjustable stages that enabled the application of strains between 0 and 100%. The composite materials were large enough to completely cover the port of the instrument both before and after mechanical actuation. The total reflectance and diffuse reflectance spectra were recorded for the composite materials under various strains at an illumination angle of 12°. The total transmittance and diffuse transmittance spectra were recorded for the composite materials under various strains at a normal illumination angle. The corresponding specular reflectance and specular transmittance spectra were calculated from the measurements according to the following equations:

$$Total reflectance ( \% ) = Specular reflectance ( \% ) + Diffuse reflectance ( \% ) \qquad ( 1 )$$

$$Total transmittance ( \% ) = Specular transmittance ( \% ) + Diffuse transmittance ( \% ) \qquad ( 2 )$$

The average reflectance and transmittance values were calculated from the spectra over the desired wavelength ranges (for example, 4.5-16.5 μm) within the mid-infrared window (that is, 2.5-25 μm). The spectra and average values were analyzed with the Spectrum (PerkinElmer) and Origin 8.5 (OriginLab) software packages. The infrared spectroscopy experiments were typically repeated on at least eight different composite materials.

Stability testing of the composite materials. The functional stabilities of the composite materials were characterized by a combination of mechanical cycling and infrared spectroscopy. The composite materials were mechanically cycled a total of 0, 1,000, 5,000 and 10,000 times between applied uniaxial strains of 0 and 50% at a frequency of 1 Hz using an ESM303 tension/compression test stand (MARK-10). The total reflectance and total transmittance spectra were obtained for the composite materials at applied strains of 0, 30 and 50% after 0, 1,000, 5,000 and 10,000 cycles using a Frontier FTIR spectrometer (PerkinElmer). The stability testing experiments were repeated on at least three different composite materials.

Thermal characterization of the composite materials on a hot plate. The thermal properties of the composite materials were characterized by standard methods. The measurements were performed using a sweating guarded hot plate (model SGHP-8.2, Thermetrics) in an integrated chamber (Thermetrics). First, the composite materials were mounted on a custom-designed holder that enabled the application of strain. Second, the holder-mounted composite materials were positioned on the hot plate and equilibrated with the surrounding chamber. Third, the thermal flux required to maintain the hot-plate temperature at a constant value was recorded as a function of time for composites subjected to strains of 0, 10, 20 or 30%. During the measurements, the hot-plate temperature was 35° C., the chamber temperature was 19.5° C., the chamber relative humidity was 50% and the laminar airflow rate was 1 m s 1. The metallized polymer material/films were characterized in analogous fashion. The collected data were analyzed with the Origin 8.5 (OriginLab) software package. The thermal characterization experiments were repeated on at least three different composite materials and space blankets.

Thermal characterization of the arch-shaped cup covers. The thermal properties of the composite material-based arch-shaped covers were characterized by a combination of thermal camera imaging and calibrated temperature measurements. The infrared pictures and apparent temperatures were recorded using a FLIR C2 thermal imaging camera (FLIR Systems). The calibrated external and internal temperatures were recorded with thermocouples using a Fluke-54-II-B data logging thermometer (Fluke Instruments). First, paper coffee cups (Starbucks) were covered with arch-shaped composite materials subjected to applied strains of 0, 10, 20 or 30%. Second, the covered cups were filled with coffee at an initial temperature of ˜85° C. Third, the thermocouples were either (1) both attached to the exteriors and positioned within the interiors of the covered cups or (2) positioned just within the interiors of the covered cups. Finally, the covered cup systems were thermally imaged at 30 min intervals over 120 min, and their external and or internal temperatures were simultaneously recorded by the thermocouples over the same time period. Bare (i.e., uncovered) coffee cups and coffee cups covered with unstrained SEBS polymer film, or unstrained metallized Mylar™ sheet, were characterized in analogous fashion. During the measurements, the temperature of the surrounding environment was ˜19° C. The cooling rate constants (k) were calculated from the external or internal temperatures according to the following equation:

$$k = \frac{d [ ln ( {T}_{c o vered cup} ) ( t ) - {T}_{e n v i r o n ment} ) ]}{d t}$$

where T_{covered cip}(t) is the external or internal temperature of the covered cup at time t and Tₑₙᵥᵢᵣₒₙₘₑₙₜ is the temperature of the environment. The relative temperature changes (ΔT) of the covered cups with respect to the bare cups (which served as de facto internal standards) were calculated from the external or internal temperatures according to the following equation:

$$Δ T = {T}_{c o vered cup} - {T}_{bare cup}$$

where T_{covered cup} is, again, the external or internal temperature of the covered cup and T_{bare cup} is the external or internal temperature of the coffee in a bare cup. The pictures and apparent temperatures were analyzed using the FLIR Tools+ (FLIR Systems) software package, and the external and internal temperature data were analyzed with the Origin 8.5 (OriginLab) software package. The thermal characterization experiments were repeated on at least four different composite material, SEBS polymer films, and metallized polymer (Mylar™) covers.

Thermal infrared camera imaging of the enclosure-integrated quilt blankets comprising the thermoregulating composite material. The thermal infrared properties of the composite material-based blankets were characterized by thermal camera imaging. The infrared pictures and apparent temperatures were recorded using a FLIR C2 thermal imaging camera (FLIR Systems). A composite material-based blanket was integrated into one side of a packaging-type enclosure with loop fasteners and then thermally imaged both before and after repeated local deformation by a hand. During the imaging, the temperature of the surrounding environment was typically ˜19° C. The thermal properties of the metallized polymer blanket were characterized in analogous fashion. The pictures and apparent temperatures were analyzed using the FLIR Tools+ (FLIR Systems) software package. The thermal infrared camera imaging experiments were repeated on at least two composite material-based blankets and analogous space blankets.

### Example 5—Computational Analysis of the IR-Reflecting Domains of the Composite Materials

The IR-reflecting domains/surface morphology of the composite materials was analyzed via standard image processing software. The SEM images obtained for the composite materials were segmented/binarized into regions that consisted of 1) IR-reflecting domains (here, Cu islands overlaying the polymer of the matrix) (green pixels) and 2) exposed underlying polymer (here, SEBS) of the elastomeric matrix (gray pixels), as schematically illustrated in FIG. 2K. For the composite materials at 0% strain, the SEM images were segmented in ImageJ (NIH) by a single-step process of applying a threshold to separate the material into two different types of regions. For the composite materials at 30%, 50%, and 100% strain, the SEM images were segmented in Mathematica (Wolfram Research) via a multistep process (as described in, for example, Gonzalez, R. C. & Woods, R. E. Digital Image Processing (Pearson Education, 2009, the disclosure of which is incorporated herein by reference). The horizontal ridgelines located at peak 2nd derivative values with respect to the y-direction were smoothed via a localized filter in order to attenuate any brightness/contrast distortion, and the pixels corresponding to the 2nd order derivative maxima in the x-direction were sharpened to enhance the desired metal island boundaries. The images were brightened by a factor of 3 to improve the contrast between the different features and further smoothed with edge preservation. The resulting images were segmented into the two different types of regions by using the native Mathematica clustering algorithm. The average widths of the IR-reflecting domains on the composite materials' surface W_{Cu} were calculated from the processed SEM images by using the following equations:

$${W}_{C u} = {W}_{p i x e l} \times \frac{{N}_{g r e e n}}{N} , \qquad ( 11 )$$

wherein Wₚᵢₓₑₗ is the width of a pixel, N_{green} is the total number of green pixels (corresponding to the Cu domains), and N is the total number of green pixel lines that span the Cu domains in the horizontal direction. Furthermore, the fractional surface coverage by Cu ρ, i.e., the ratio of the Cu domains' areas to the entire surface's area, were calculated from the processed SEM images by using the following equation:

$$ρ = \frac{{N}_{g r e e n}}{{N}_{g r e e n} + {N}_{g r a y}} \times 100 \% , \qquad ( 12 )$$

where N_{gray} is the total number of gray pixels (corresponding to the exposed polymer of the elastomeric matrix). These calculations enabled a quantitative evaluation of the composite materials' surface morphology.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A method of fabricating a composite material with adjustable IR-reflecting properties and having a continuous area of more than 150 cm² comprising:
providing a flexible substrate characterized by a substrate surface roughness;
depositing a planar layer comprising a first IR-reflecting material and characterized by a planar layer thickness onto the flexible substrate;
growing a plurality of columnar nanostructures comprising a second IR-reflecting material on top of the planar layer at an angle relative to the planar layer to obtain a nanostructured layer characterized by a nanostructured layer thickness;
coating the nanostructured layer with an IR-transparent polymer and allowing the IR-transparent polymer to dry to obtain an elastomeric matrix, characterized by a matrix thickness, such that the nanostructured layer becomes embedded into the elastomeric matrix via the plurality of columnar nanostructures, to provide a robust composite; and
delaminating the robust composite from the flexible substrate, such that the planar layer breaks into a plurality of domains comprising the first IR-reflecting material, separated by a plurality of spacings comprising the IR-transparent polymer,
to produce a free standing film having the continuous area of more than 150 cm² and comprising the composite material with adjustable IR-reflecting properties.

2. The method of claim 1, wherein the substrates surface roughness is characterized by a surface roughness RMS value of <1 μm.

3. The method of claim 1, wherein the flexible substrate comprises a material selected from the group consisting of: metal foil, plastic, rubber.

4. The method of claim 3, wherein the metal foil is aluminum foil.

5. The method of claim 1, wherein the first IR-reflecting material and the second IR-reflecting material are materials independently selected from the group consisting of: copper, aluminum, gold, silver, any oxide of titanium, any oxide of vanadium, any oxide of molybdenum, and any oxide of silicon, and any combination thereof.

6. The method of claim 1, wherein the first IR-reflecting material and the second IR-reflecting material are same materials.

7. The method of claim 1, wherein the planar layer thickness is 10-100 nm.

8. The method of claim 1, wherein the IR-transparent polymer is a material selected from the group consisting of: SEBS polymers, including various SEBS blends and blends of SEBS with PE and HDPE, PDMS, and any combination thereof.

9. The method of claim 1, wherein the coating is achieved via a technique selected from the group consisting of: spray-coating, spin-coating, doctor blading, knife coating, slot-die coating, any other solution-based or neat material coating technique, and any combination thereof.

10. The method of claim 1, wherein the matrix thickness is 30-40 μm.

11. A method of fabricating a part characterized by a part shape of a part area of less than 150 cm² comprising a composite material with adjustable IR-reflecting properties comprising:
providing a flexible substrate characterized by a substrate surface roughness;
depositing a planar layer comprising a first IR-reflecting material and characterized by a planar layer thickness onto the flexible substrate;
growing a plurality of columnar nanostructures comprising a second IR-reflecting material on top of the planar layer at an angle relative to the planar layer to obtain a nanostructured layer characterized by a nanostructured layer thickness;
coating the nanostructured layer with an IR-transparent polymer and allowing the IR-transparent polymer to dry to obtain an elastomeric matrix, characterized by a matrix thickness, such that the nanostructured layer becomes embedded into the elastomeric matrix via the plurality of columnar nanostructures, to provide a robust composite; and
delaminating the robust composite from the flexible substrate, such that the planar layer breaks into a plurality of domains comprising the first IR-reflecting material, separated by a plurality of spacings comprising the IR-transparent polymer,
to produce a free standing film having the continuous area of more than 150 cm² and comprising the composite material with adjustable IR-reflecting properties; and
excising the part shape from the free standing film to obtain the part.
